(19) United States
(12) Patent Application Publication
(10) Pub. No.: US 2025/0340238 A1
(43) Pub. Date: Nov. 6, 2025

(54) MULTI-FUNCTIONAL CHILD'S TRAVEL DEVICE

(71) Applicant: SCOOT & RIDE HOLDING GMBH, Grieskirchen (AT)

(72) Inventors: Robert KIRCHSCHLAGER, Leonding (AT); Wolfgang BERNDORFER, Natternbach (AT)

(73) Assignee: SCOOT & RIDE HOLDING GMBH, Grieskirchen (AT)

(21) Appl. No.: 18/864,709

(22) PCT Filed: May 8, 2023
(86) PCT No.: PCT/EP2023/062146

§ 371 Date: Nov. 11, 2024

(30) Foreign Application Priority Data
May 12, 2022 (AT) A50341/2022

(51) Int. Cl. B62B 13/06; A63C 17/26; A63C 17/28; A63G 13/10; B62K 3/00; B62K 9/00

(52) U.S. Cl. CPC B62B 13/06; A63C 17/265; A63C 17/28; A63G 13/10; B62B 2206/006; B62K 3/002; B62K 9/00

(57) ABSTRACT

The invention relates to a travel device for children comprising a panel with a first side and a second side, wherein the first side has at least one first sliding surface with first sliding characteristics for sliding the surface on the ground, and the second side has at least one single wheel for moving the travel device on the ground in a movement direction, wherein the first side has a first seating/standing surface and/or the second side has a second seating/standing surface, the first side and/or the second side has a first receiving device or a second receiving device for detachably arranging a seat/holding element, with said seat/holding element being produced from a solid material or from an expandable or inflatable element, wherein the receiving device is designed for arranging the seat/holding element in a horizontal position or in a vertical position relative to the panel.

### CROSS-REFERENCE TO RELATED APPLICATIONS

The present application is a national phase application of PCT Application No. PCT/EP2023/062146, filed May 8, 2023, entitled “MULTI-FUNCTIONAL CHILD'S TRAVEL DEVICE”, which claims the benefit of Austrian Patent Application No. A50341/2022, filed May 12, 2022, each of which is incorporated by reference in its entirety.

### BACKGROUND OF THE INVENTION

### 1. Field of the Invention

The invention relates to a vehicle for children.

### 2. Description of the Related Art

CA2762892A1 discloses a vehicle, which vehicle comprises a second side with wheels for rolling on a ground. Said vehicle, however, does not comprise a plate with such a second side and a first side for sliding or swinging on a ground.

WO2020053855A1 discloses a vehicle, which vehicle, however, does not comprise wheels and a sliding surface for alternate use.

Known in prior art are vehicles under the product name wheelybug. It is not disclosed on the website www.wheelybug.de that the plate of the vehicle comprises a first side with a sliding surface and a second side with wheels.

The vehicles disclosed on the website shop.chillafish.com do not comprise a first side with a sliding surface and a second, opposite side with wheels. The element which is designed for sitting on the vehicle cannot be releasably arranged on a plate with these sides. The sliding surface is not formed to be planar; the toddler can use the vehicle for swinging (USD878480S).

The vehicle disclosed in each of U.S. Pat. No. 6,676,148B1, CN104973184A, WO2021040620A1,U.S. Pat. Nos. 5,441,289A, 10,470,585B2, TW201707758A, ES1009546U, JPH0528392U, CN206950648U does not comprise a plate having a first side with an essentially planar sliding surface and a second side with rollers for alternate use.

CN212395837U comprises a plate with wheels arranged on a second side, which plate, however, does not include a sliding surface on the side opposite the second side. The sides of the plate from CN212395837U do not comprise dwelling surfaces. The plate comprises recesses for receiving the bloatable element.

The vehicle disclosed in US2002164917A1 does not comprise a plate with a sliding surface arranged on its first side and with wheels arranged on its second site opposite the first side.

The difference between the invention described below and ITPD20090281 becomes clear, for example, based on the sectional view in FIG. 6 of ITPD20090281. The reference numeral 12 designates operating means, which implies that said means are necessarily required to use the device disclosed in ITPD20090281. The presence of the operating means precludes any use of the surface arranged on the top in FIG. 6 as a sliding surface.

USD878480 discloses a vehicle having a bent sliding surface only on a first side. The vehicle does not comprise wheels on the second side.

U.S. Pat. No. 2,595,839 shows a vehicle with a slide. The vehicle comprises wheels on the one side, but the other side cannot be used as a sliding surface due to the elevations. The slide comprises a planar surface on the one side, but the other side is not formed as a single bent surface.

DE29722538 discloses a vehicle with wheels, but without a sliding surface.

The online link https://jamara.com/manuals/files/460504_460505_460506_2in1Sommer_WinterBob_DE_GB_FR_IT_ES.pdf reveals another vehicle with a sliding surface on the first side and at least one wheel on the second side. The sides each comprise a dwelling surface. The vehicle shown by this link does not comprise a receiver for arranging a seating/holding element on either the first side or the second side.

US2019193770, FIG. 6 shows a vehicle having a first side executed as a sliding surface and a side provided with at least one wheel, wherein the vehicle further comprises ropes as holding elements 224, 229, 225, 227. US2019193770, FIG. 6 shows that the vehicle disclosed in D1 comprises holding elements as strings. There is no indication in US2019193770 that the holding elements are releasably arranged on the plate. A rope is a flexible element. US2019193770 thus does not disclose that the holding element is formed out of a solid or inflatable or bloatable material. A solid material is understood to mean a material which can be arranged in special layers and maintains said assigned layers. US2019193770 does not disclose that the handles can be arranged in a vertical position by being inserted into a receiving device. Moreover, this is not possible due to the softness of the ropes. It can be seen from US2019193770, FIG. 6, for example, that the bores for receiving the ropes extend horizontally as handles. Thus, not even the subregion of the rope extending within the bore is arranged vertically as a handle.

### SUMMARY OF THE INVENTION

The invention disclosed herein has the object of providing a vehicle for toddlers, which vehicle can be used in a plurality of constellations. A toddler undergoing a growth process is thereby to be provided with a plurality of possible applications to support the development of their motor function.

The invention relates to a vehicle for children comprising
a plate having a first side and a second side,
which sides are arranged opposite or at an arrangement angle to one another and form the top side of the plate and the bottom side of the plate, respectively, when the vehicle is used.

The plate may be a single plate.

The plate or a subregion of the plate may comprise multiple elements, which elements may be assembled into one element that statically or dynamically acts as a plate. The plate may also comprise a hinge, as discussed below.

According to the invention, this is achieved by the independent claims.

The inventive vehicle may be characterized in that
the first side comprises at least one first sliding surface having first sliding properties for the surface to slide on the ground,
which first sliding surface is formed as a planar sliding surface extending across a subregion of the first side or across the entire first side, and
the second side comprises at least a single wheel to displace the vehicle into a movement direction on a ground,
wherein the first side comprises a first dwelling surface and/or the second side comprises a second dwelling surface,
wherein the first side and/or the second side comprises a first receiving device and a second receiving device, respectively, to releasably arrange a seating/holding element,
which seating/holding element can be formed as an element, which element can be converted from a first position for use as a seating element into a second position for use as a holding element or which seating/holding element is exclusively formed as a seating element or which seating/holding element can be exclusively formed as a holding element,
which seating/holding element is made out of a solid material or out of a bloatable or inflatable element,
wherein the receiving device is formed to arrange the seating/holding element in a horizontal position or in a vertical position with respect to the plate.

The first sliding surface may be a single sliding surface. The first sliding surface may also be formed as multiple first sliding surfaces. The multiple first sliding surfaces may be spaced apart from one another and thus executed separately. The multiple first sliding surfaces may also be formed adjacent to one another.

In its contact region with the ground, the sliding surface comprises a surface planar and/or smooth in both extending directions of the surface for contacting a ground. The sliding surface may also be formed as a sliding surface in the surfaces adjacent to the contact region with the ground.

In its contact region with the ground and optionally in surfaces adjacent to or adjoining said contact region, the longitudinal extension of the sliding surface may be oriented essentially parallel to the movement direction of the inventive vehicle and parallel to a relative movement direction between the sliding surface and the ground. The planar sliding surface extends parallel to the special shape of a planar ground.

In an advantageous manner, the sliding surface does not comprise partial surfaces which extend transversely to the movement direction. In this advantageous embodiment, the sliding surface comprises only partial surfaces which extend longitudinally essentially parallel to the movement direction. The partial surfaces mentioned herein do not need to be visible as such.

The sliding surface may not have any bends in a contact region with the ground and optionally in the surfaces adjacent to or adjoining the contact region and thus be formed as a planar geometrical surface.

The planar sliding surface has the technical effect that, when used in a common manner and moved on the planar ground, the sliding surface is in contact with the ground over its entire surface, preventing a swinging relative movement or a relative movement changing the extension of the contact surface between the sliding surface and the ground. The planar sliding surface may comprise planar subregions in different height positions. A planar surface may have a cascading design.

Additionally or alternatively to the planar formation of the sliding surface described above, the same may also be bent once or multiple times.

The bent sliding surface may be bent only about a first axis, which first axis is oriented at a 90° angle to the movement direction. Bending about multiple axes is also possible.

A sliding surface may be characterized by a frictional coefficient smaller than 0.5.

The second side may comprise a single wheel. The second side may also comprise multiple wheels. A person of skill in the art will choose the number of wheels depending on the desired rolling properties of the vehicle.

The first receiving device on the first side and the second receiving device on the second side are described in the disclosure of the invention below.

The seating/holding element may be formed as an element, which element can be converted from a first position for use as a seating element into a second position for use as a holding element. The seating/holding element can be exclusively formed as a seating element. The seating/holding element can be exclusively formed as a holding element. This definition is applicable to the entire disclosure of the invention.

In its use as a seating element or as a holding element or as an element convertible from a seating element into a holding element and vice versa, the seating/holding element may be formed as a rigid element.

In its use as a seating element, the seating/holding element extends essentially horizontally. In its use as a holding element, the seating/holding element extends essentially vertically. A rigid element may be defined such that the element, when used as intended and under a common amount of load, is defined only to such extent that use of the rigid element for this purpose is possible.

The seating/holding element may thus be formed as a rigid element. The seating/holding element as a holding element, in particular as a holding rod, may be executed to be non-bendable. The property of sufficient rigidity implies being made out of a solid material.

The seating/holding element may be made out of a bloatable of inflatable element.

The plate and/or the seating/holding element may be made out of a plastic or a foamed material such as EPP. Use of a foamed material is particularly advantageous in that it may allow a child to lift the inventive vehicle. Furthermore, a lower weight will allow a child to push the inventive vehicle in a sliding or rolling manner.

The inventive vehicle may be formed such that the inventive vehicle is moved into a conceived movement direction with regard to its conception. Said movement direction may be dictated by the shape of a wheel. The movement direction may be dictated by the shape of a sliding surface, wherein a sliding surface, similar to the skids of a sled or ski, for example, normally and when travelling straight ahead, has its largest extension parallel to the conceived movement direction.

The above solution comprises the seating/holding element being releasably attached on one side of the plate via the receiving device.

The inventive vehicle may be characterized in that
the first side comprises at least one first sliding surface having first sliding properties for the surface to slide on the ground,
which first sliding surface is formed as a planar sliding surface extending across a subregion of the first side or across the entire first side, or
which first sliding surface is formed as a single surface extending across the first side and bent about a first axis,
which first axis extends at a 90° angle to the movement direction and in a first plane spaced apart from the ground, and
the second side comprises at least a single wheel to displace the vehicle into a movement direction on a ground,
wherein the first side comprises a first dwelling surface and/or the second side comprises a second dwelling surface,
wherein a seating/holding element formed integrally with the plate is arranged on the first side and/or on the second side,
which seating/holding element can be formed as an element, which element can be converted from a first position for use as a seating element into a second position for use as a holding element or which seating/holding element is exclusively formed as a seating element or which seating/holding element can be exclusively formed as a holding element,
which seating/holding element is made out of a solid material or out of a bloatable or inflatable element,
wherein the receiving device is formed to arrange the seating/holding element in a horizontal position or in a vertical position with respect to the plate.

The seating/holding element may also be executed integrally with the plate.

A sliding surface formed as a single surface that is bent about the first axis or planar may be formed as a surface with indentations or protrusions that is continuous or formed out of one element or material. The indentations or protrusions may run tangentially to the bent surface.

The sliding surface may be bent about a single first axis. The sliding surface may be bent about said one first axis exclusively. Bending of the sliding surface about further axes is also possible within the invention.

The embodiments of the inventive vehicle described above comprise a sliding surface on the first side and wheels to displace the inventive vehicle on a ground on the second side. This formation defines two sides of the inventive vehicle, which two sides have different movement properties at a relative movement v>0 with respect to a ground.

The different movement properties may be achieved by providing sliding surfaces with different properties.

The inventive vehicle may be characterized in that
the first side comprises a first sliding surface having a first sliding property,
the second side comprises a second sliding surface having a second sliding property,
wherein the first sliding surface and the second sliding surface are formed to be planar,
the first sliding property and the second sliding property being different.

The different sliding properties may be achieved by different geometrical formations of the sliding surfaces. Additionally or alternatively, the different sliding properties may be achieved by forming the sliding surfaces with different frictional coefficients for the ground.

When the first side is used as the first sliding surface, the second side serves as the second dwelling surface. When the second side is used as the second sliding surface, the first side serves as the first dwelling surface.

The inventive vehicle may be characterized in that
the first side comprises a first sliding surface having a first sliding property,
the second side comprises a second sliding surface having a second sliding property, wherein
one sliding surface is formed to be planar and
one sliding surface is formed as a single bent surface,
which bent sliding surface extends across the first side in a subregion of the first side or across the entire first side and
is bent about a first axis,
which first axis extends at a 90° angle to the movement direction and in a first plane spaced apart from the ground,
wherein the first side comprises a first dwelling surface and/or the second side comprises a second dwelling surface.

The invention disclosed herein generally provides that the inventive vehicle be movable on a ground sliding with the first side down or rolling or sliding with the second side down. By turning the plate or the seating/holding element of the inventive vehicle, the first side or the second side may be selectively oriented towards the ground.

A toddler may dwell on the respectively upwards-facing dwelling surface by sitting or standing or kneeling or in any other posture.

Since no boundaries should be set for the toddler with regard to the way the toddler dwells on the dwelling surface, the term ‘dwelling surface’ is used. The dwelling surface is generally a surface which is formed such that a toddler can dwell on it by sitting or standing or in any other way without changing or adapting the dwelling surface.

The dwelling surface may have bolstering.

The dwelling surface and/or the plate may be formed to be elastically and/or plastically deformable, so that a person with an excess of weight will deform the dwelling surface or plate such that movement of the plate is prevented.

The dwelling surface may have a rough surface to prevent the child from gliding off.

The inventive vehicle may be characterized in that
the first side comprises a first sliding surface having a first sliding property,
the second side comprises a second sliding surface having a second sliding property, wherein
the sliding surfaces are formed as a bent surface, each bent about a first axis,
which first axis extends at a 90° angle to the movement direction and in a first plane spaced apart from the ground,
wherein the first side comprises a first dwelling surface and/or the second side comprises a second dwelling surface.

In the two most recently mentioned embodiments, the first sliding properties and the second sliding properties may be the same or different. In particular, the first sliding surface and the second sliding surface may have equal or different frictional coefficients with respect to the ground.

The invention disclosed herein may be based on the use of a single plate.

The invention disclosed herein may be based on the use of multiple plates, which plates are preferably connected to a construction element that acts as a static plate. Connection of the elements may be executed such that the operator can release or lock the connections of the construction elements when converting the inventive vehicle into a storing position. The user may, for example, release or lock the connections depending on the use of a seating/holding element to be described below or depending on the position of the user on the vehicle.

In its contact region with the ground and optionally in the surfaces adjacent to or adjoining the contact region in a longitudinal extension and (relative) movement direction, the planar or bent sliding surface may have a bigger dimension than transversely to the longitudinal extension or (relative) movement direction.

A planar or bent sliding surface may be characterized by the surface load transferred from the sliding surface to the ground not exceeding a threshold value, so that neither the sliding surface nor the ground become deformed by a common load and in a typical state of use. The surface load is to be chosen by dimensioning the sliding surface such that a child pushing the vehicle or a child located on and accelerating the vehicle can overcome static friction acting between the sliding surface and the ground.

A sliding surface which is moved relative to and in contact with a ground, may undergo deformation in particular at its front edges as seen in the movement direction. The front edge can also easily get caught in uneven parts of the ground. The front edge of a planar or bent sliding surface may be shorter than the longitudinal extension direction of the sliding surface. The planar or bent sliding surface may comprise a scoop shape in the area of its front edge, which scoop shape comprises a bending or other surface extending away from the ground.

The inventive vehicle may comprise multiple planar sliding surfaces dispersed over the first side of the plate and extending over subregions of the first side. The planar sliding surfaces may be arranged in the corner region of the first side of the plate. This is also applicable to those further inventive embodiments which comprise a sliding surface.

A bent sliding surface may allow the child to swing. When swinging, there is always a risk of a child getting caught between the moving sliding surface and the ground. In this context, it is to be noted that a higher number of edges increases the risk of getting caught, which is why only a bent sliding surface is provided to increase safety.

An edge of the sliding surface may be arranged at a distance from the edge of the first side. The skilled person chooses the distance between the edge of the sliding surface and the edge of the first side to be big enough so that a child cannot put their hand or fingers under the sliding surface. The inventive vehicle may be characterized by the first sliding property and the second sliding property being different.

The sliding property of a surface is determined by the design of the surface and the choice of material. The choice of material for a side may define the frictional coefficient of said side with respect to the ground.

The skilled person may thereby form sides with different sliding properties to allow the child using the inventive vehicle different sliding experiences when using the different sides. This is applicable to all embodiments of the vehicle with a sliding surface. The inventive vehicle may comprise a holding device or generally an element suitable for holding on or grabbing, which holding device or element is arranged adjoining or within the dwelling surface, so that a child dwelling on the dwelling surface can hold on to the holding device.

The above description relates, among other things, to sliding surfaces bent once. Sliding surfaces bent twice are also possible.

A sliding surface may have a planar surface.

A sliding surface may have a surface bent once or multiple times concavely or convexly or in any other way.

In general, a sliding surface may be made out of a material not deformable under typical loads.

In general, a sliding surface may be made out of an elastically and/or plastically deformable material. A sliding surface made out of a deformable material may further allow a bouncing movement of the child together with the vehicle, with flexible and/or dampening properties of the material supporting or preventing such movement.

The sliding surface may comprise deformable cavities, which cavities are filled with a gas at normal pressure or excess pressure.

The inventive vehicle may be characterized in that
the bent sliding surface is formed as a sliding surface bent about a second axis,
which second axis extends at a 90° angle to the movement direction and in a second plane spaced apart from the ground.

The inventive vehicle preferably comprises a sliding surface bent about a single axis or multiple axes on one side and a planar sliding surface or at least one wheel on the other side. The feature of at least one wheel is understood to mean that the other side comprises a single wheel or multiple wheels.

The sliding surface may, for example, be in the shape of an ellipsis.

The inventive vehicle may be characterized in that
the sliding surface is bent about multiple first axes and/or multiple second axes.

The shape of the bent sliding surface is not limited to an arcuate shape in any view. The bending may also be in the shape of a subregion of an ellipsis. According to the current teaching, an ellipsis comprises to foci, which is why a surface bent approximating an ellipsis has multiple bending axes parallel to one another.

The mentioned sliding surfaces may be in any shape. The sliding surfaces may be bent into one direction or multiple directions.

The sliding surface may comprise multiple arcs or curves either spaced apart from one another or continuous.

The sliding surface may be in a wave shape.

The inventive vehicle may be characterized in that
the first sliding properties and the second sliding properties are different.

The feature of different sliding properties is discussed above based on the potential embodiment of the planar shape of the first sliding surface and the second sliding surface. It is also possible for the bent and planar sliding surfaces or for the bent sliding surfaces to have different sliding properties among one another.

In the literature, the sliding property of one surface is described by the frictional coefficient with respect to another surface.

The inventive vehicle may be characterized in that
the movement direction is oriented parallel to or at an angle to a longitudinal extension direction of the plate or the sliding surface.

The angle mentioned is preferably an acute angle, i.e. an angle of between 1° and 45°, preferably between 10° and 30°.

However, a 90° angle or an angle other than 90° are also possible.

The inventive vehicle may be characterized in that the movement direction can be chosen by the toddler at will. The inventive vehicle may have no preferred direction of travel.

The inventive vehicle may comprise at least two sliding surfaces, wherein the longitudinal extension direction of the sliding surfaces are arranged with respect to one another at the angle mentioned.

The inventive vehicle may comprise at least two sliding surfaces, wherein the longitudinal extension direction of the sliding surfaces are arranged with respect to one another at the angle mentioned, symmetrically with the movement direction.

As explained above based on one embodiment, the seating/holding element may be arranged on one side of the plate via a receiving device. Those inventive embodiments described without such a receiving device may nevertheless comprise such a receiving device.

The inventive vehicle may be characterized in that
the first side and/or the second side comprises a first receiving device and a second receiving device, respectively, to releasably arrange a seating/holding element.

The receiving device may be executed as releasable mechanical connecting means for mechanically connecting the plate and the seating/holding element. The receiving device may be reduced to preventing relative movement between the plate and the seating/holding element under typical loads and/or movements by the connection created.

The receiving device may create a clear arrangement of the seating/holding element on and with respect to the plate. This can be achieved by fitting congruent shapes into one another.

The mechanical connection may prevent, for example, separation of the plate and the seating/holding element by lifting the plate or the seating/holding element from the ground. The skilled person may design the mechanical connection such that, to lift the plate or the seating/holding element, additional effort or additional releasing of the connection is required for separating the plate and the seating/holding element.

The additional effort may be achieved, for example, by a jamming mechanical connection and/or by a latching mechanical connection. The mechanical connection may, for example, be a dovetail joint known according to the current teaching. In an arrangement of the seating/holding element, the receiving device may have a bias, which bias counteracts release of the seating/holding element and/or shifting of the seating/holding element relative to the plate.

The mechanical connection may also comprise partial surfaces, which partial surfaces are oriented at an angle and thus not parallel to a separating movement of plate and seating/holding element, so that said partial surfaces serve as locking surfaces and separation of plate and seating/holding element is possible only upon deformation of said locking surfaces. Preferably, the locking surfaces are made out of an elastic material. A locking surface may prevent movement of an element in that the element is moved against the locking surface and the locking surface prevents further movement of the element in the direction of the locking surface.

The seating/holding element applied to the first side or to the second side may extend across or cover the entire extension of the respective side or across subregions of the respective side.

The inventive vehicle may be characterized in that
the receiving device for arranging the seating/holding element is formed for use as a seating element,
wherein the seating/holding element arranged in a horizontal position comprises seating means on its surface opposite the first side or the second side.

The receiving device and the seating/holding element may have congruent shapes with respect to another to arrange the seating/holding element in its horizontal position. The horizontal position may be defined by the contact of the congruent shapes.

The seating/holding element may comprise seating means, on which seating means a toddler can sit. The seating means may have the shape of a saddle, providing the toddler good support.

The seating/holding element formed for sitting on the seating/holding element is arranged above the plate and connected to the plate via the receiving device of the respective side to transfer powers. The connection is preferably executed in a releasable manner to allow versatile design of the inventive vehicle.

A potential use of the inventive vehicle involves the toddler who sits on the seating means accelerating the vehicle with their feet or hands by sliding or gliding or rolling. The vehicle can further be pulled by another person.

The seating/holding element may have a seating/holding element side adapted in shape to the first side and/or the second side. The seating/holding element side may, for example, comprise recesses, inside which recesses the wheels can be arranged when the seating/holding element is arranged on the second side.

The inventive vehicle may be characterized in that
a holding device is arranged adjoining the seating means.

The holding device may be in a shape such that the toddler who sits on the seating/holding element can hold on. In an advantageous manner, the holding device has a round or chamfered shape without sharp edges to avoid injury. The holding device may, for example, be in a T-shape or an annular shape.

Preferably, the holding device is arranged at a front end or a rear end of the vehicle as seen in the movement direction. A child standing in front of or behind the vehicle can thus hold on to the holding device. The inventive vehicle thus serves a means of learning to walk.

The holding device may be releasably attached to the seating/holding element.

The seating/holding element may be releasably attached to the plate. Optionally, the holding device may extend through the seating/holding element. The holding device may be used to fix the seating/holding element to the plate.

As mentioned above, a holding device may be arranged adjoining the dwelling surface. This holding device may also be arranged adjoining the seating means.

The holding device may be brought into a position adjoining the seating means from its position adjoining the dwelling surface.

The seating/holding element may be arranged with respect to the holding device adjoining the dwelling surface such that the holding device is arranged after the arrangement of the seating/holding element adjoining the seating means.

The holding device in all its mentioned embodiments and arrangements may be executed to be releasable or adjustable with respect to the plate or to the seating/holding element.

The holding device may be arranged above the adjustable wheels in the projection.

The inventive vehicle may be characterized in that
the receiving device is formed to attach the seating/holding element on the plate,
wherein the seating/holding element arranged in a vertical position comprises a planar or bent sliding surface on its surface facing the ground opposite the first side or the second side.

The receiving device and the seating/holding element may be in congruent shapes, which congruent shapes define the vertical position in the case of contact.

The seating/holding element comprising a planar or bent sliding surface is arranged on the bottom side of the plate. Said seating/holding element contacts the ground on which the inventive vehicle is moved.

For example, the seating/holding element with a sliding surface on a second side, which second side comprises wheels, may be arranged between said wheels. The seating/holding element may assign a sliding function to the inventive vehicle or a vehicle in general (scooter) in its position with the second side comprising the wheels facing downwards in the case of a planar execution. In the case of a bent execution, the inventive vehicle in its position with the second side facing downwards may be assigned a swing function and/or a sliding function.

The skilled person may form the seating/holding element described herein independently of the inventive vehicle.

The inventive vehicle may be characterized in that
the receiving device is formed to attach the seating/holding element to the plate in a vertical position,
which seating/holding element comprises at holding device at its free end.

The inventive vehicle may be characterized by a seating/holding element being arrangeable on the plate in a horizontal position or in a vertical position. The sides of the plate comprise a receiving device suitable for this purpose or multiple receiving devices suitable for this purpose.

In particular, the seating/holding element arranged vertically on the plate has a holding function for a toddler dwelling on the dwelling surface of the plate. For example, the toddler may stand or sit on the dwelling surface and hold on to the holding device arranged at a free end of the seating/holding element or arranged in the longitudinal extension of the seating/holding element.

The holding device may be releasably fixed on the vertically arranged seating/holding element. The holding device may be formed integrally with the seating/holding element.

The holding device may be arranged on the plate. The holding device may extend through the horizontally or vertically arranged seating/holding element.

A potential use of the inventive vehicle may be that the toddler who stands or in another way dwells on the plate accelerates the vehicle with their feet by sliding or rolling or swinging.

As discussed above based on an embodiment, the seating/holding element may be formed integrally with the plate. Those inventive embodiments which are described without such a seating/holding element may comprise such a seating/holding element integrally formed with the plate.

The inventive vehicle may be characterized in that
a seating/holding element formed integrally with the plate is arranged on the first side or on the second side.

An embodiment among the above embodiments may be characterized by at least a single wheel being arranged on the second side of the plate. Generally, arrangement of a single wheel is possible. Multiple wheels may also be arranged in any position with respect to one another, such as, for example, adjacent in the direction of travel.

The at least one wheel may be driven.

The inventive vehicle may be characterized in that
the vehicle comprises at least one front wheel and/or at least one rear wheel.

The at least one front wheel and/or the at least one rear wheel are arranged on the second side of the plate. In an advantageous manner, the vehicle comprises at least three wheels, i.e., at least two front wheels and one rear wheel or at least one front wheel and two rear wheels.

The inventive vehicle may comprise two front wheels and two rear wheels.

The inventive vehicle may be characterized in that
at least one front wheel and/or at least one rear wheel and/or the sliding surface can be set so as to change the movement direction.

The inventive vehicle may comprise a weight-shift steering and/or rotary steering setting the front wheel or wheels and/or the rear wheel or wheels and/or the sliding surface. In the case of a weight-shift steering, the child dwelling on the dwelling surface or on the seating/holding element can set the front wheel or the rear wheel or the sliding surface by shifting their weight and thus change the movement direction of the inventive vehicle. The child may also control the weight-shift steering by changing the forces acting on the seating/holding element and/or on the plate.

The inventive vehicle may comprise a rotary steering setting the front wheel or wheels and/or the rear wheel or wheels and/or the sliding surface, which rotary steering is operated by the user. Actuation of the rotary steering may be by the seating/holding element and/or by the holding device and/or by subregions of the dwelling surface and/or the holding rod.

The steering of the inventive vehicle may also be formed as a so-called self-setting steering, where the wheel or wheels are supported so as to rotate about an essentially vertical axis, or an axis tilted towards the vertical plane. The skilled person knows, for example, rollers which are set sideways or straight ahead upon movement of the plate.

Known in prior art are a weight-shift steering and/or a rotary steering. No explanation of their functionality is required.

A wheel and/or the sliding surface may be settable relative to the plate or a plate subregion. Likewise, a plate subregion may be alternatively or additionally settable with respect to a further plate subregion, so that setting of a wheel and/or sliding surface into the movement direction is achieved.

The front wheel or wheels and/or the rear wheel or wheels may be supported merely about a rotation point or rotation axis, so that the respective wheels is set into the movement direction of the vehicle automatically.

The inventive vehicle may be characterized in that
the plate comprises a front plate region and a rear plate region,
which plate regions are connected by a single hinge or by multiple hinges.

The plate may comprise two plate parts, which are connected by the hinge and can be set with respect to one another by said hinge. The plate may be executed having a seating/holding element.

The hinge may be executed as a ball hinge.

The hinge may be formed as a hinge having a single hinge axis.

The inventive vehicle may be characterized in that
the hinge has a hinge axis or the hinges each have a hinge axis,
which hinge axis or axes are oriented at a right angle or parallel or at an angle to the plate extension of the plate.

A hinge axis oriented at a right angle to the plate extension or to the plate plane may cause steering of the vehicle by setting the plate regions with respect to one another. The hinge axis may be arranged in the middle of the plate. For example, a so-called snakeboard is known; the plate may be formed as a snakeboard.

A hinge axis oriented parallel to the plate extension may allow turning a plate region relative to the other plate region. Exemplary embodiments for this embodiment are found below.

The inventive vehicle may be characterized in that
at least one receiving device among the receiving devices is formed in the shape of tongue and groove,
wherein the tongue is introduced into the groove, or
at least one receiving device is formed as a covering connection.

One or more receiving devices or all receiving devices may be formed as indicated above.

The tongue or the groove may be arranged at a right angle to the plate. The tongue or the groove is thus oriented vertically in the case of a typical horizontal extension of the plate. This allows good transfer of horizontal forces between the plate and the seating/holding element. The groove is formed such that the tongue can engage it.

Tongue and groove may be executed in a clamping fashion.

The groove and/or the tongue may be formed circumferentially around the circumference or a subregion of the circumference of a side of the plate or the circumference or a subregion of the circumference of a contact surface of the seating/holding element, which contact surface is contacted with said side of the plate.

Instead of or in addition to a tongue-and-groove connection, other releasable mechanical connections such as, by way of example rather than limitation, latching connections, screwing connections, magnets may be provided, which are suitable for transferring the common forces between the seating/holding element and the plate. Aids such as bolts, dowels may also be used for plugging the elements to be connected. Such a bolt may be formed integrally with the plate or the seating/holding element. The elements to be connected such as the plate may also, for example, be connected by a hook-and-loop fastener or by a zip fastener.

The skilled person using their knowledge in the art may form the receiving device such that the receiving device is suitable for transferring the forces required.

In a covering connection, a seating/holding element may be placed over the plate in a subregion or in multiple subregions or entirely. The seating/holding element may enclose the plate in its covering position.

In a covering connection, the plate may be placed over the seating/holding element in a subregion or in multiple subregions or entirely. The plate may enclose the seating/holding element in its covering position.

A potential embodiment of a covering connection is a folded connection.

The receiving device may also comprise a belt, a buckle or another biasing device, which biasing device is used to press the seating/holding element against the plate in the position to be achieved. Providing a such biasing device in prior art may allow the contact surface between the seating/holding element and the side of the plate to be executed without any special feature, i.e., essentially planar.

The holding element guided to the plate through the seating/holding element may be attached to the plate such that the seating/holding element can be pressed against the side of the plate.

The inventive vehicle may be characterized in that
at least one receiving device among the receiving devices extends along the edges or subregions of the plate.

A single receiving device or multiple receiving devices or all receiving devices may be formed according to the above feature.

The edge region of a plate is clearly visible for a person when a seating/holding element is arranged on the plate. Said clear visibility of the edge region has the further advantage of the person being able to assemble or release the receiving devices of plate and seating/holding element easily. This is advantageous in particular when the toddler wishes to arrange the seating/holding element on the plate or remove it from the same.

The inventive vehicle may be characterized in that
the receiving device is formed in a subregion of the receiving device or the entire receiving device is formed as a receiving hinge or connector.

The receiving hinge connects the plate with the seating/holding element.

The receiving hinge may be executed as a ball hinge. The seating/holding element can be set in any way with respect to the plate.

The receiving hinge may be formed as a hinge with a hinge axis, so that the seating/holding element can be set with respect to the plate only be rotating or pivoting about the hinge axis.

The hinge axis may extend in a plane parallel to or within the plate plane. The hinge axis may be oriented at a right angle or parallel or at a 45° angle to the longitudinal extension direction of the plate.

The hinge axis may also be oriented at an angle to the plate plane, so that the seating/holding element can be set with respect to the plate by a pivoting movement. Said angle may be, for example, the angle bisector between a horizontal position of the seating/holding element and a vertical position of the seating/holding element.

The above description comprises the feature of the receiving device of the seating/holding element being releasable on the plate. The hinge may be executed so as to be releasable.

The hinge may, for example, be executed as a tongue-and-groove connection, wherein a rotating movement of the groove within the tongue is permitted. Said rotating movement of the groove may be enabled, for example, by the tongue-and-groove connection being released in a different subregion.

The receiving device may also be executed as a connector. In this case, the plate and the seating/holding element are assembled in a direction dictated by the formation of the connector.

The inventive vehicle may be characterized in that
at least one receiving device among the receiving devices comprises a distancing element.

A single receiving device or multiple receiving devices or all receiving devices may be formed according to this feature.

Typically, a connection between two elements such as the receiving device herein between the plate and the seating/holding element has a clearance. Such a clearance may create noises when the vehicle slides on a ground, which noises can be prevented by a dampening distancing element inside the receiving device.

The distancing element may extend across subregions of the receiving device. Multiple distancing elements extending across subregions of the receiving device may be arranged inside the one receiving device or inside the receiving devices.

The distancing element may also cause the seating/holding element to be spaced apart from the plate and thus the seating/holding element being adjusted in height on the plate. The height of the seating/holding element may thus be adapted to the size of the child relative to the plate.

The distancing element may have other material properties than the plate and/or the seating/holding element. For example, the distancing element may have a flexible or dampening property.

The inventive vehicle may be characterized in that
the first side comprises rills.

The rills are preferably arranged between singular sliding surfaces to prevent noises when the vehicle slides on a ground.

The inventive vehicle may be characterized in that
at least one wheel among the wheels can be converted from a rolling position into a storing position.

By converting at least one wheel among the wheels from a use position into a storing position, the second side comprising the wheel or wheels, in particular the region between a front wheel and a rear wheel, may contact the ground. Said region may thus be assigned use as a sliding surface or a swinging surface.

The inventive vehicle may be characterized in that
the second side comprises wheel cases as a receiving device for the wheels or a chassis with at least one wheel.

At least one wheel may protrude in part from the wheel case. The wheel case may provide space for a suspension and/or a steering.

The height of the wheel may be changed inside the wheel case.

The inventive vehicle may be characterized in that
the seating/holding element and/or the plate are formed as a hollow body, so that the seating/holding element and/or the plate form a stowage space and/or the seating/holding element forms a stowage space with the plate.

In an advantageous manner, the receiving device extends on the edge of the seating/holding element and/or on the edge of the plate when a stowage space is provided inside the seating/holding element. The seating/holding element may comprise a sealable opening such as a hatch for filling the stowage space, for example.

The stowage space may provide space for receiving a weight. By arranging a weight inside the vehicle, the required acceleration force may be controlled to move the vehicle in a sliding manner.

A potential use of the inventive vehicle is an aid for learning to walk, where a toddler pushes the inventive vehicle in a sliding or rolling manner. By arranging the weight, the acceleration force required for pushing the vehicle in said sliding or rolling manner may be controlled and the child supported in their learning process. Likewise, the focal point of the vehicle near the ground or within the vehicle may be changed by arranging the weight. Thereby, tipping of the vehicle may be prevented or intentionally permitted by arranging the weight.

The inventive vehicle may be characterized in that
the plate has an indentation on the first side and/or on the second side.

The indentation may be part of the stowage space. The indentation may also be part of or form the dwelling surface.

The inventive vehicle may be characterized in that
the plate and optionally the seating/holding element are made out of EPP.

The material is essentially an elastically deformable material in order to prevent damage to an object and the vehicle when the vehicle has hit such an object.

The plate and/or the seating/holding element may in their core be made out of such an elastically deformable material and comprise a foil or a plastic cladding on their surface.

The plate and/or the seating/holding element may have a higher density in subregions of their surfaces. By this it may be achieved that the material becomes more resistant to collisions.

The inventive vehicle may be characterized in that
the sliding surface comprises subregions with different sliding properties.

The sliding surface may, for example, comprise a subregion in which a piece of felt is arranged, while in other subregions the sliding surface is made out of a plastic. Felt is characterized by low frictional resistance at a sliding movement on hard surfaces such as wood or stone. Furthermore, the said hard surface is not damaged.

The inventive vehicle may be characterized in that
the surfaces of the plate and optionally the seating/holding element are coated with a foil-like material or textile.

The inventive vehicle may be characterized in that
a pull strap is connected to the plate and/or the seating/holding element with a first pull strap end,
wherein the pull strap comprises a pulley handle on its second free end.

The inventive vehicle may be characterized in that
the plate and/or the seating/holding element comprises a recess or a protrusion to receive the pull strap and optionally the pulley handle.

The pulley handle and/or the pull strap may be inserted into the recess in a clamping manner, i.e., upon deforming the plate and/or the seating/holding element. The pulley handle and/or the pull strap is then held in the recess in a clamping manner.

In an advantageous manner, the first end of the pull strap is pulled into an interior for or when inserting the pulley handle into the recess. A spool for winding up the pull strap may also be provided.

The inventive vehicle may be characterized in that
the pull strap comprises a spool for winding up the pull strap on the first pull strap end and/or the second pull strap end.

The pull strap is thus assigned another function.

The inventive vehicle may be characterized in that
a vibration motor is arranged on the plate or within the plate or optionally on the seating/holding element or optionally within the seating/holding element.

The vibration motor sets the vehicle in vibration, which vibration changes the friction between the sliding surface and the ground. A vehicle set in vibration is easier to be moved on a ground in a rolling or sliding manner.

The inventive vehicle may be characterized in that
the vibration motor can be driven by the pull rope.

The vibration motor may comprise an unbalance driven by a spring. By actuating the pull rope, the spring may be pulled up, whereby the pull rope is assigned another function.

The inventive vehicle may be characterized in that
the plate is formed as a prism with four sides,
wherein one side or multiple sides or all sides of the prism are formed as a planar or bent sliding surface or comprise wheels.

In its cross-sectional area, which cross-sectional area is oriented at a 90° angle to the direction of travel or to the ground, the prism may be in the shape of a square or a rectangle or a trapezoid or in a circular shape or an elliptical shape or another shape. The different side faces or lateral partial surfaces of the prism may be formed as sliding surfaces or provided with a single wheel or wheels. Special properties such as height or inclination towards the ground may be assigned to the sides via the position of the prism.

The inventive vehicle may be characterized in that
the plate comprises a sliding surface that can be set with respect to one side of the plate.

For example, the height of the sliding surface may be executed so as to be settable with respect to the side of the plate. In the most simple case imaginable, this may be achieved by the sliding surface being applied to the side as a seating/holding element with a certain thickness.

Furthermore, an inclination of the sliding surface towards the side can be set. The inventive vehicle may be characterized in that
the plate has a greater width on its end than in its middle region.

In this execution, a child who sits on the plate can easily place their feet on the ground.

The inventive vehicle may be characterized in that
the seating/holding element has a greater width on its end than in its middle region.

In this execution, a child who sits on the seating/holding element can easily place their feet on the ground.

The inventive vehicle may be characterized in that
the plate comprises a first plate and a second plate,
wherein the first plate and the second plate can be set with respect to one another.

The plate does not necessarily have to be formed as a single plate. The plate may comprise a first plate and a second plate, which first and second plates are connected via a mechanical connection. The mechanical connection may be a plate hinge, which plate hinge allows setting the first plate with respect to the second plate. Preferably, the mechanical connection is such that the first plate and the second plate act as one plate in terms of statics and dynamics.

The inventive vehicle may be characterized in that
the plate and the seating/holding element are in merging shapes.

To be used as a vehicle for children, the vehicle does advantageously not have any sharp edges.

### BRIEF DESCRIPTION OF THE DRAWINGS

The invention is additionally discussed based on the following embodiments represented in the Figures:

FIG. 1 to FIG. 16 schematically show different embodiments of the inventive vehicle.

FIG. 17 to FIG. 33 show embodiments of different prototypes of the inventive vehicle.

### DETAILED DESCRIPTION

The embodiments shown in the Figures merely show potential embodiments, and it should be noted at this point that the invention is not limited to these specifically illustrated variant embodiments thereof, but combinations of the individual embodiment variants among each other and a combination of one embodiment with the above general description are possible. This further potential combination do not have to be expressly mentioned, since these further potential combinations are within the skill and knowledge of a person of skill in the relevant technical field based on the technical teaching by the present invention.

In particular, the skilled person can combine the features on the formation of the plate including the sides and the seating/holding element.

The embodiments described below, which embodiments comprise a seating/holding element, comprise a plate having a receiving device to releasably attach the seating/holding element to the plate. In particular, the skilled person can apply the above description of an integral formation of the plate and the seating/holding element to these embodiments and provide an integral formation of plate and seating/holding element instead of the receiving device.

The integral formation may be such that the plate and the seating/holding element are connected by connecting means, which connection may only be released by a person applying excessive force or using special tools, or by breaking.

Integral formation may be such that the plate and the seating/holding element are made in one piece. The plate and the seating/holding element may be foamed out of foam raw material or injected out of plastic raw material in one process step.

The skilled person may combine the information above and the information on the shape of the plate mentioned in the context of the embodiments below with each other. Such a combination comprises the shape of the plate with regard to the sliding surfaces and with regard to the layout.

The skilled person may read together the information above and the information on the shape and the connection of the seating/holding element established using the receiving device, including the type of connection and the characteristic of the connection, mentioned in the context of the embodiments below.

The scope of protection is determined by the claims. The description and the drawings on the other hand should be consulted for interpretation of the claims.

In the Figures, the following elements are designated by the preceding reference numerals.
1 plate
2 first side
3 second side
4 front wheel
5,5′ rear wheel
6 ground
7 movement direction
8, 8′ (seating/holding) element
9 seating means
10 seating/holding element sliding surface
11 holding device
12 front plate area
13 rear plate area
14 hinge between plates
15 stowage space
16 indentation
17 hinge between plate and seating means
18 first dwelling surface
19 second dwelling surface
20 receiving hinge
21 first side length
22 second side length
23 third side
24 fourth side
25 first plate portion
26 second plate portion
27 free
28 grooves
29 first surface
30 first sliding surface
31 first sliding surface
32 first sliding surface
33 first sliding surface
34 notch
35 wheel case
36 wheel case
37 wheel case
38 wheel case
39 second (sliding) surface
40 receiving device for holding device
41 recess in sliding surface
42 distancing element
43 stowage space
44 protrusion in sliding surfaces
45 edge
46 edge
47 scooter carriage
50 first opening (of first plate 1)
51 (free)
52 opening (of the seating/holding element 8)
53 stop (arranged in plate 1)
54 stop (arranged in seating/holding element)

In the Figures, not necessarily all elements are designated by the reference numerals mentioned so as to preserve clarity in individual cases. When features of an embodiment are mentioned below in reference to a further embodiment previously described, this implies that the embodiment differs from said further embodiment in those features. The other features that are not mentioned are the same in the embodiment and the further embodiment.

An arrangement of a seating/holding element on a plate described below conditions providing a receiving device to establish a releasable connection between the seating/holding element and the plate, if the plate and the seating/holding element are formed integrally.

The following contains statements according to which claims the respective embodiment is to be regarded as an inventive embodiment. Such statements are understood to be exemplary rather than limiting.

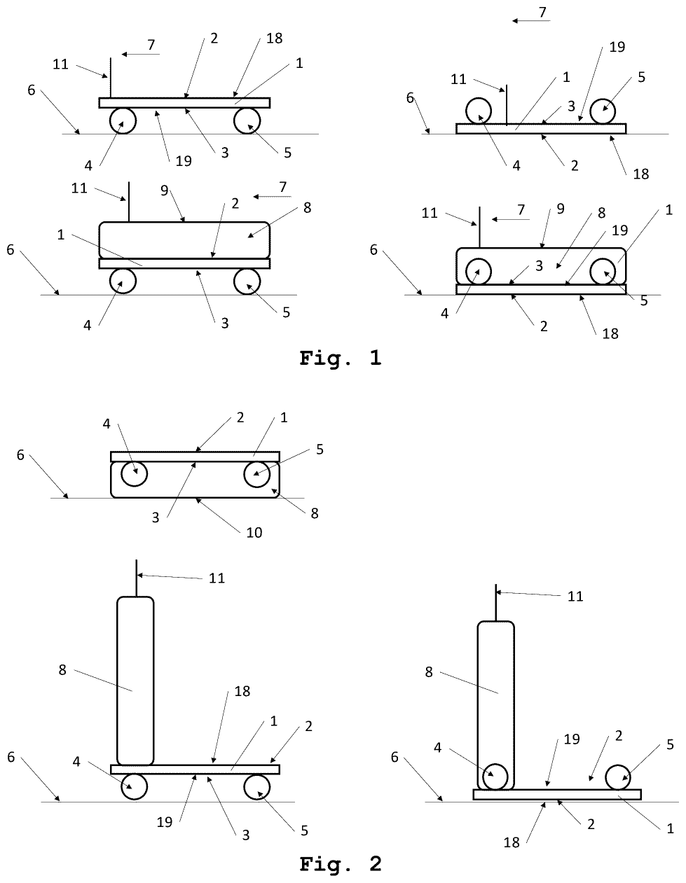

FIG. 1 and FIG. 2 show a first potential embodiment of the inventive vehicle, which embodiments comprise the plate 1 and a seating/holding element 8.

The inventive vehicle for children comprises a plate 1 oriented horizontally with respect to a ground 6 and having a first side 2 and a second side 3. The said sides 2, 3 are arranged opposite one another. FIG. 1 shows the special case of the sides 2, 3 extending parallel to one another. A position of the sides 2, 3 at an angle other than 90° is also possible.

The plate 1 may be rectangular in its cross-sectional shape (at a right angle to the plane of FIGS. 1 and 2), for example. The plate 1 may be triangular in its cross-sectional shape (at a right angle to the plane of FIGS. 1 and 2), for example.

Depending on the use of the vehicle, the sides 2, 3 form the top side of the plate 1 and the bottom side of the plate 1, respectively.

The first side 2 comprises a single first sliding surface with first sliding properties for the surface to slide on the ground 6. It is also possible that the first side 2 comprises multiple first sliding surfaces. The first sliding surface is formed as a planar sliding surface extending across a subregion of the first side 2 or as a planar sliding surface extending across the entire first side 2.

The second side 3 comprises at least one wheel, in particular a front wheel 4 and/or a rear wheel 5 to displace the vehicle on a ground 6 into a movement direction 7. FIG. 1 shows the special case of the second side 3 comprising at least one front wheel 4 and at least one rear wheel 5.

The first side 2 may comprise a first dwelling surface 18 and/or the second side 3 may comprise a second dwelling surface 19.

The plate 1 may be moved on the ground 6 on the wheels 4, 5 rolling into a movement direction 7 with the second side 3 facing the ground 6, as shown on the top left of FIG. 1. Furthermore, the plate 1 may be moved on the ground 6 sliding into a movement direction 7 with the first side 2 facing the ground 6, as shown on the top right of FIG. 1.

A seating/holding element 8 may be arranged horizontally on the plate 1.

The seating/holding element 8 may be arranged horizontally adjacent to the first side 2 via a first receiving device. The receiving device may be made as releasable mechanical connecting means according to the above description. A receiving device formed as releasable mechanical connecting means has the advantage that the constellations of the vehicle shown in FIGS. 1 and 2 may be achieved by removing and attaching the seating/holding element 8.

A vehicle shown in FIGS. 1 and 2 with a removable and attachable seating/holding element is a vehicle according to claim 1 optionally read together with at least one claim dependent on claim 1.

The seating/holding element 8 and the plate 1 may also be made integrally.

A vehicle shown in FIGS. 1 and 2 with an integral formation of plate 1 and seating/holding element 8 is a vehicle according to claim 2 optionally read together with at least one claim dependent on claim 2.

The embodiment shown on the top left of FIG. 1, which does not comprise a seating/holding element 8, is not an inventive embodiment.

The embodiment shown on the top right of FIG. 1, which does not comprise a seating/holding element, is not an inventive embodiment.

The embodiment shown on the bottom left of FIG. 1 is an inventive embodiment according to claim 1 or claim 2 optionally read together with at least one dependent claim.

The inventive vehicle comprising the plate 1 and the seating/holding element 8 may be moved rolling on the ground 6, wherein the top side of the seating/holding element forms seating means 9, as shown on the bottom left of FIG. 1.

The seating/holding element 8 may be arranged on the first side 2 via the releasable receiving device.

The seating/holding element 8 may be formed integrally with the plate 1, wherein the seating/holding element 8 is arranged on the first side 2.

The embodiment shown on the bottom right of FIG. 1 is an inventive embodiment according to claim 1 or claim 2 optionally read together with at least one dependent claim.

The seating/holding element 8 may be arranged horizontally to the second side 3, wherein the seating/holding element is formed as a receiving device for the wheels 4, 5. The receiving device of this embodiment and the further embodiments may be formed according to the above description.

Furthermore, the top side of the seating/holding element forms a seating means 9, on which seating means 9 a child can dwell. The child may progress with the inventive vehicle having the first side 2 sliding on a ground 6 into a movement direction 7, as shown on the bottom right of FIG. 1.

Horizontal arrangement of the seating/holding element 8 on the plate 1 suggests that the top side of the seating/holding element forms a seating means 9.

The inventive vehicle may have a holding device 11 in the positions and constellations shown.

The embodiment shown on the top of FIG. 2 is an inventive embodiment according to claim 1 (releasable receiving device) or claim 2 (integral formation of plate 1 and seating/holding element 8) optionally read together with at least one dependent claim. In particular, claim 2 may be combined with claim 22.

It is also possible for the seating/holding element 8 to be arranged on the second side 3 facing downwards using the second receiving device. The seating/holding element 8 is formed as a receiving device of the wheels 4, 5. A child dwelling on the first dwelling surface 18 may move with the vehicle sliding on the ground 6 into a movement direction 7, wherein the bottom side of the seating/holding element 8 forms a seating/holding element sliding surface 10 for sliding on a ground 6. Formation of a bent seating/holding element sliding surface 10 for sliding and/or swinging on a ground 6 is also possible. The embodiment shown on the top of FIG. 2 is possible only with a removable arrangement of the seating/holding element 8, which seating/holding element 8 is placed over the wheels 4, 5 and thus envelops the wheels 4, 5. The embodiments shown on the bottom of FIG. 2 are inventive embodiments according to claim 1 (releasable receiving device) or claim 2 (integral formation of plate 1 and seating/holding element 8) optionally read together with at least one dependent claim.

The seating/holding element 8 may also be arranged on the plate 1 in a vertical position, as shown on the bottom of FIG. 2. The seating/holding element 8 may be arranged in a vertical position on the first side 2, see the bottom left of FIG. 2, or on the second side 3, see the bottom right of FIG. 2. In its vertical position, the seating/holding element 8 serves as a holding element for a child standing on the first dwelling surface 18 or on the second dwelling surface 19. Depending on the wheels 4, 5 in contact with the ground 6, see the bottom left of FIG. 2, or the planar sliding surface, see the bottom right of FIG. 2, the vehicle is moved either rolling or sliding on the ground 6 into a movement direction 7.

Vertical arrangement of the seating/holding element 8 requires formation of the seating/holding element 8 out of a rigid, in particular non-bendable material.

The seating/holding element 8 is arranged adjacent to the first side 2 using the first receiving device, as shown on the bottom left of FIG. 2. The child dwelling on the first dwelling surface 18 may hold on to the vertically arranged seating/holding element 8 or to the holding element 11 attached to the seating/holding element 8.

The seating/holding element 8 is arranged adjacent to the second side 3 using the second receiving device, as shown on the bottom right of FIG. 2. The seating/holding element 8 is formed in the region of the second receiving device with respect to the receiving device of the front wheel 4. The child dwelling on the second dwelling surface 19 may hold on to the vertically arranged seating/holding element 8 or to the holding element 11 attached to the seating/holding element 8.

Formation of plate 1 and seating/holding element 8 is also possible instead of providing the releasable receiving device.

The representations in FIGS. 1 and 2 are based on the horizontally arranged seating/holding element 8 extending across the entire surface of the adjacent side 2, 3. It is also possible for the horizontally extending seating/holding element 8 to extend only across a subregion of the adjacent side 2, 3, as shown in FIG. 3.

FIG. 3 shows inventive embodiments according to claim 1 (releasable receiving device) or claim 2 (integral formation of plate 1 and seating/holding element 8) optionally read together with at least one dependent claim.

In analogy to the representations in FIGS. 2 and 3, the skilled person can also envision a vertically arranged seating/holding element 8, which seating/holding element 8 extends across the entire adjacent side 2, 3, which is not shown in FIGS. 2 and 3. FIGS. 2 and 3 show a seating/holding element 8, which seating/holding element extends across subregions of the sides 2, 3.

In FIGS. 1 to 3, the receiving devices may be formed, for example, as a connector when designed according to claim 1 optionally read together with at least one dependent claim. The seating/holding element 8 can be plugged onto the plate 1 in a direction dictated by the formation of the connector.

The seating/holding element 8 shown in FIGS. 1 to 3 is formed out of a solid material. The seating/holding element 8 has sufficient non-bendability in particular in its position as a holding element, so that a child standing on a dwelling surface 18, 19 can hold on to the holding element (see the bottom of FIG. 2). The seating/holding element 8 has sufficient non-bendability in its position as a seating element for a child to be able to sit on the seating means 9 or on the plate 1 (see the bottom of FIG. 1; see the top of FIG. 2; see FIG. 3).

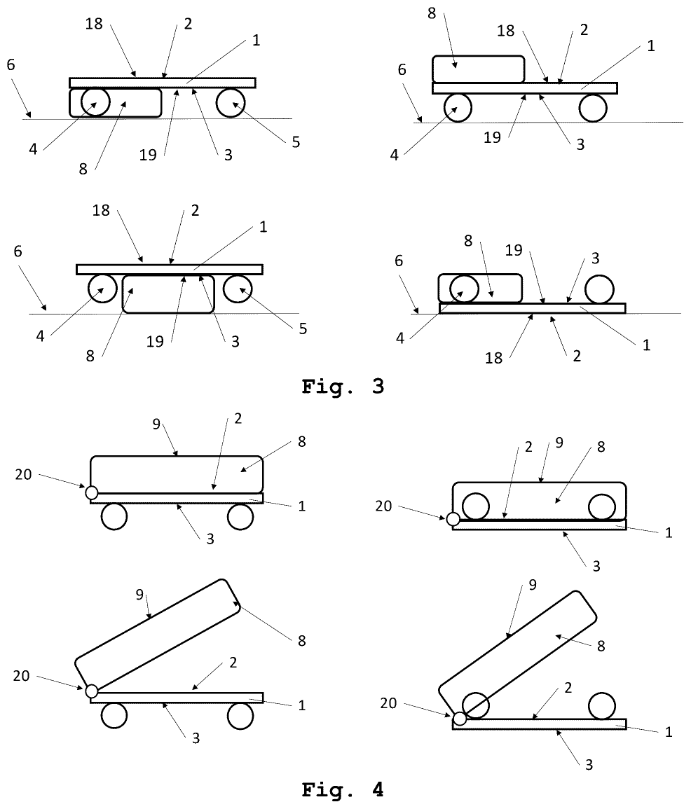

FIG. 4 shows an inventive embodiment according to claim 1 (releasable receiving device) or claim 2 (integral formation of plate 1 and seating/holding element 8) optionally read together with at least one dependent claim.

FIG. 4 shows a particular embodiment of the receiving devices. The receiving device may comprise a receiving hinge 20, so that the seating/holding element can be applied to the plate 1 in a rotating or pivoting manner.

In an embodiment with a releasable receiving device according to claim 1 optionally read together with at least one dependent claim, the hinge 20 may be formed as a mechanical hinge or out of a deformable material.

In an embodiment with integral formation of plate 1 and seating/holding element 8, the hinge may be formed as a mechanical hinge, wherein the hinge parts of the hinge 20 cannot be opened. As an alternative to the mechanical hinge, the hinge 20 may be made out of a deformable material, which deformable material is inserted into the mold, for example, by foaming or injecting the plate 1 and the seating/holding element 8, thus making a single workpiece.

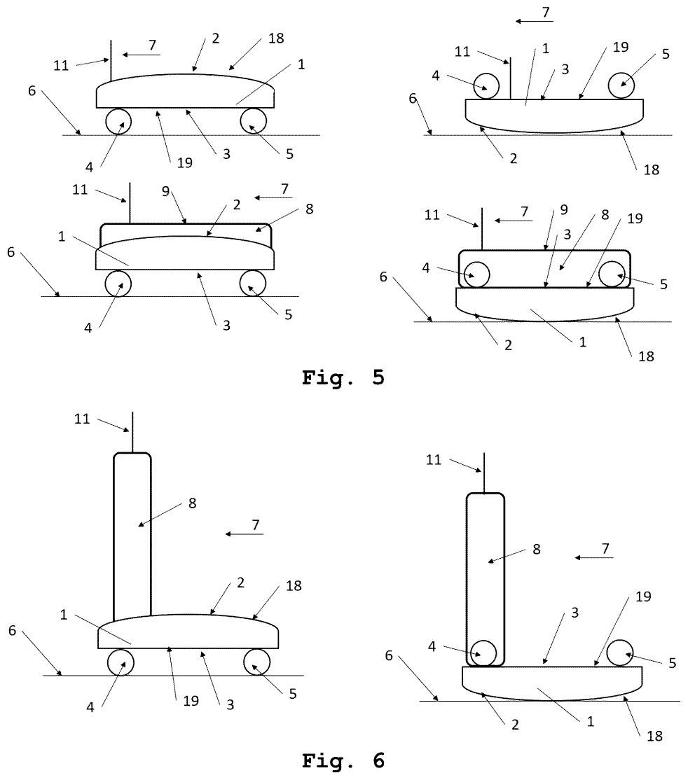

The top left and right of FIG. 5 show an inventive embodiment according to claim 4 optionally read together with at least one dependent claim.

FIG. 5 shows a further embodiment of plate 1, which plate 1 comprises a first side 2 with a first bent sliding surface. The plate 1 comprises a second side 3 with at least one wheel, specifically at least one front wheel 4 and at least one rear wheel 5.

When the wheels 4, 5 contact the ground 6, the vehicle can be moved on a ground 6 rolling into a movement direction 7 with the second side 3 facing downward, as shown on the top left of FIG. 5. The first side 2 comprises a first dwelling surface 18.

When the first side 2 contacts the bent sliding surface, the vehicle can be moved on a ground 6 swinging and/or sliding into a movement direction 7, as shown on the top right of FIG. 5. The second side 3 comprises a second dwelling surface 19.

The bottom left and right of FIG. 5 show an inventive embodiment according to claim 1 (releasable receiving device) or claim 2 (integral formation of plate 1 and seating/holding element 8) optionally read together with at least one dependent claim. The embodiments shown on the bottom left and right of FIG. 5 are also embodiments according to claim 4 read together with claim 10 and optionally other claims.

A horizontally arranged seating/holding element 8 may be arranged adjacent to the first side 2 using a first receiving device, wherein the top side of the seating/holding element 8 serves as a seating means 9. This is shown on the bottom left of FIG. 5.

A horizontally arranged seating/holding element 8 may be arranged adjacent to the second side 3 using a second receiving device, wherein the top side of the seating/holding element 8 serves as a seating means 9. This is shown on the bottom right of FIG. 5. In subregions, the seating/holding element is executed so as to be hollow in order to receive the present wheels 4, 5.

The embodiments shown are preferably formed so as to the holding element 11 being arrangeable adjoining the seating means 9.

FIG. 6 shows an inventive embodiment according to claim 1 (releasable receiving device) or claim 2 (integral formation of plate 1 and seating/holding element 8) optionally read together with at least one dependent claim. The embodiment shown in FIG. 6 is also an embodiment according to claim 4 read together with claim 10 and optionally at least one other dependent claim.

When the inventive vehicle is formed according to claim 1, FIG. 6 shows other constellations of the inventive vehicle associated with FIG. 5, in which a vertical seating/holding element 8 is arranged on the first side 2, see the left of FIG. 6, or on the second side 3, see the right of FIG. 6.

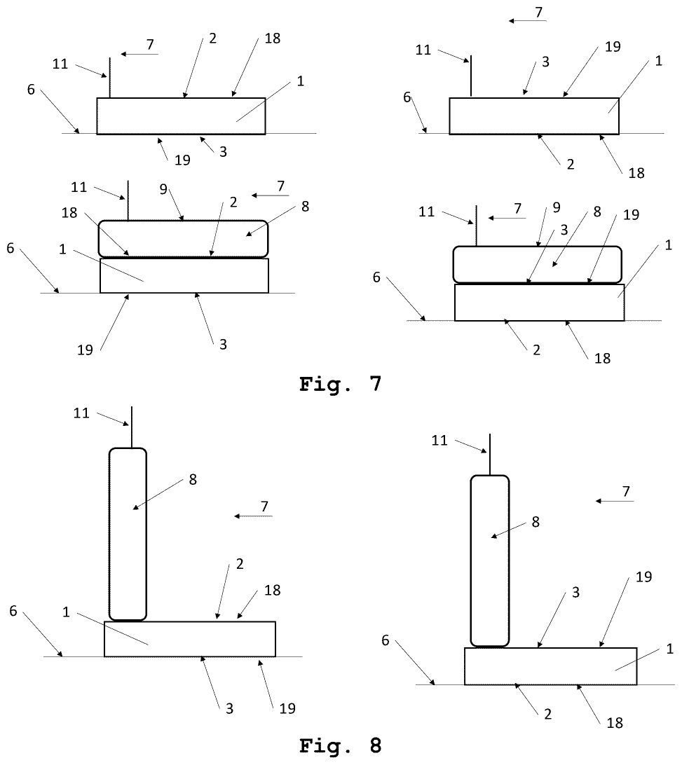

The top of FIG. 7 shows inventive embodiments of the vehicle according to claim 3 optionally read together with another claim.

The top of FIG. 7 shows another embodiment of the plate 1, which plate 1 comprises a first side 2 with a planar sliding surface and a second side 3 with a planar sliding surface. The sides 2, 3 are sides opposite to the plate 1, which sides are formed parallel to one another in the special form shown in FIG. 7. The sides 2, 3 form the top and bottom sides of plate 1.

The sliding surfaces extend across the entire respective side or across subregions of the respective side. The sliding surfaces have different sliding properties to slide on the ground 6.

The bottom of FIG. 7 and FIG. 8 show inventive embodiments according to claim 3 optionally read together with at least one dependent claim.

A seating/holding element 8 may be arranged adjacent to the first side 2 in a horizontal position (see the bottom left of FIG. 7) and in a vertical position (see the left of FIG. 8). Furthermore, a seating/holding element 8 may be arranged adjacent to the second side 3 in a horizontal position (see the bottom right of FIG. 7) and in a vertical position (see the right of FIG. 8). Such arrangement is via the releasable receiving device when executed according to claim 1 or via integral formation in the case of integral formation of plate 1 and seating/holding element 8.

The seating/holding element is made out of one body, so that a child standing on the dwelling surface 18, 19 can hold on to the holding element. Also, it is achieved by the formation of the seating/holding element out of a solid material that a child can sit on the seating means 9.

The embodiment of FIGS. 7 and 8 is characterized by the different sliding properties resulting in different sliding movements. The child as the user may selectively contact the first side 2 or the second side 3 with the ground 6 and thereby choose the sliding properties of the inventive vehicle. This applies to all constellations of this embodiment of the inventive vehicle shown in FIGS. 7 and 8.

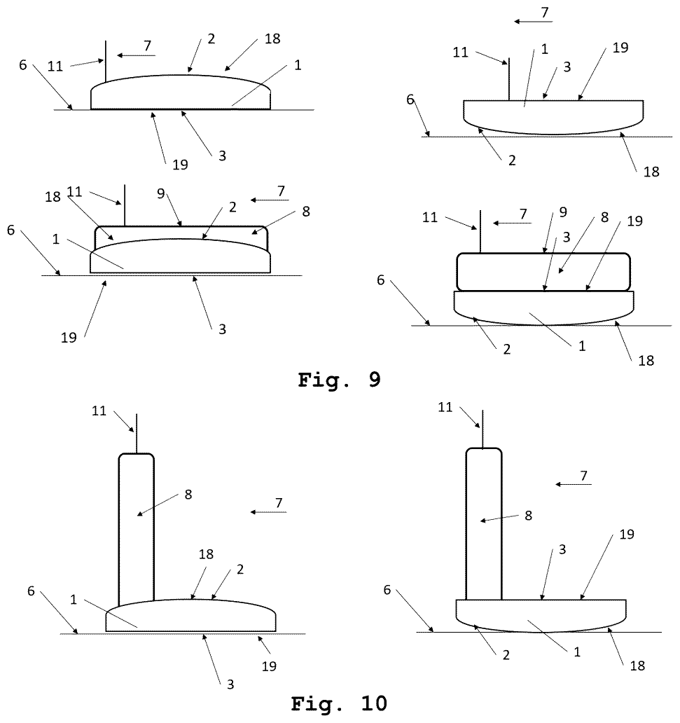

The top of FIG. 9 shows an inventive embodiment according to claim 4 optionally read together with at least one dependent claim.

The bottom of FIG. 9 and FIG. 10 show another embodiment of the inventive vehicle in again different constellations according to claim 4 optionally read together with at least one dependent claim.

The first side 2 comprises a sliding surface that is formed bent. When the first side 2 contacts the ground 6, the vehicle can be moved swinging and/or sliding on the ground 6 into a movement direction 7. The second side 3 on the top side of the plate 1 may serve as a second dwelling surface 19 (see the top right of FIG. 9).

The second side 3 comprises a sliding surface that is formed to be planar. When the second side 3 contacts the ground 6, the inventive vehicle is moved sliding into a direction of travel 7. The first side 2 as the top side of the plate 1 may serve as a first dwelling surface 18 (see the top left of FIG. 9).

Furthermore, a seating/holding element 8 may be contacted with the first side 2 (see the bottom left of FIG. 9) or the second side 3 (see the bottom right of FIG. 9), wherein the top side of the seating/holding element 8 may serve as a seating means 9. The embodiment shown on the bottom of FIG. 9 and in FIG. 10 is an inventive embodiment based on the seating/holding element 8 arranged on one side. The seating/holding element 9 may in turn be arranged in a vertical position adjacent to the first side 2 (see the left of FIG. 10) or adjacent to the second side 3 (see the right of FIG. 10), so that a child standing on the first dwelling surface 18 or the second dwelling surface 19, respectively, can hold on to the seating/holding element 8. In the positions mentioned, the seating/holding element 8 may comprise a holding element 11.

The sliding surfaces of the first side 2 and the second side 3 may have different sliding properties. The inventive vehicle may have different travelling properties depending on the side 2, 3 contacted with the ground 6 due to the different sliding properties and/or due to the different designs of the sliding surface.

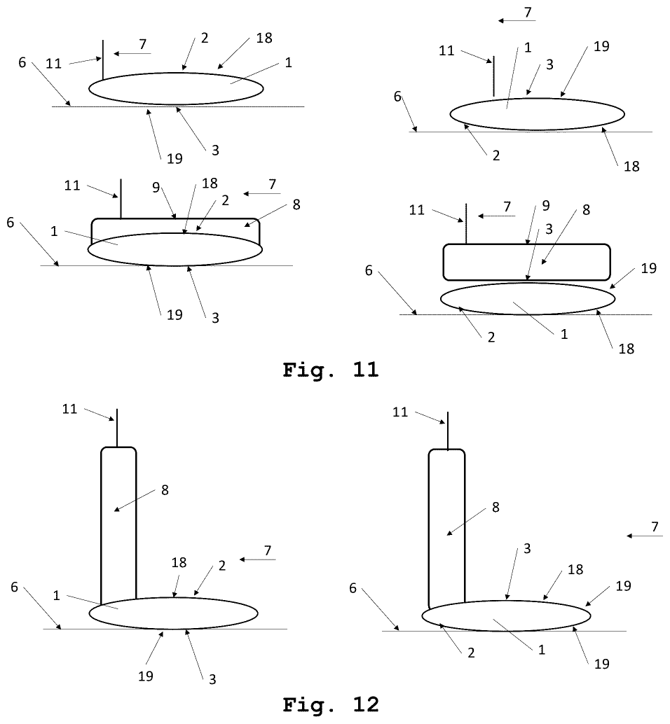

FIGS. 11 and 12 show another embodiment of the inventive vehicle according to claim 5 optionally read together with at least one claim 5. It comprises the first side 2 and the second side 3 as a bent sliding surface, so that the inventive vehicle can be moved sliding and/or swinging into a movement direction 7 when the first side 2 or the second side 3 contacts the ground 6.

The first side 2 and the second side 3 are sliding surfaces with similar or equal bends. The sides 2, 3 may also have differently bent sliding surfaces.

The sliding surfaces of the sides 2, 3 may also have different sliding properties.

The inventive vehicle may have different travelling properties depending on the side 2, 3 contacted with the ground 6 due to the different sliding properties and/or due to the different designs of the sliding surface.

FIGS. 11 and 12 show in turn the arrangement of a seating/holding element 8 in a horizontal position, see the bottom of FIG. 11, and in a vertical position, see FIG. 12, via a releasable receiving device. The above description of the Figures is applicable analogously to FIGS. 11 and 12.

Instead of a releasable receiving device, integral formation of plate 1 and seating/holding element 8 may also be provided.

FIG. 13 shows another inventive embodiment according to claim 1 optionally read together with another dependent claim. FIG. 13 is also an embodiment according to claim 4 read together with claim 4 read together with dependent claim 15 and optionally another dependent claim.

FIG. 13 illustrates another feature of the inventive vehicle based on the example of the embodiment shown in FIGS. 1 and 2. However, this feature is also applicable to the other embodiments of the vehicle.

FIG. 13 illustrates the feature of the wheels 4, 5 that can be introduced into the plate 1. This requires the plate to be sufficiently thick and formed hollow in at least the respective subregions of plate 1 to form a receiving space for receiving the wheels 4, 5.

The top left of FIG. 13 shows a first use of the inventive vehicle according to claim 4 read together with claim 15, which vehicle is moved rolling on a ground 6 into a movement direction 7 on the wheels 4, 5. The first side 2 on the top side may serve as the dwelling surface 18.

At least one wheel 4, 5 may be displaced into the plate 1. The bottom left of FIG. 13 shows the wheels 4, 5 in a retracted position, so that the vehicle can be moved sliding into a movement direction 7 when the second side 3 contacts the ground 6. The bottom left of FIG. 13 and the bottom right of FIG. 13 thus show the inventive embodiment according to claim 4 read together with claims 15 and 22 as well as optionally at least one dependent claim.

When the first side 2 contacts the ground 6, the second side 3 serves as the second dwelling surface 19, wherein the wheels 4, 5 introduced into the plate 1 do not interfere.

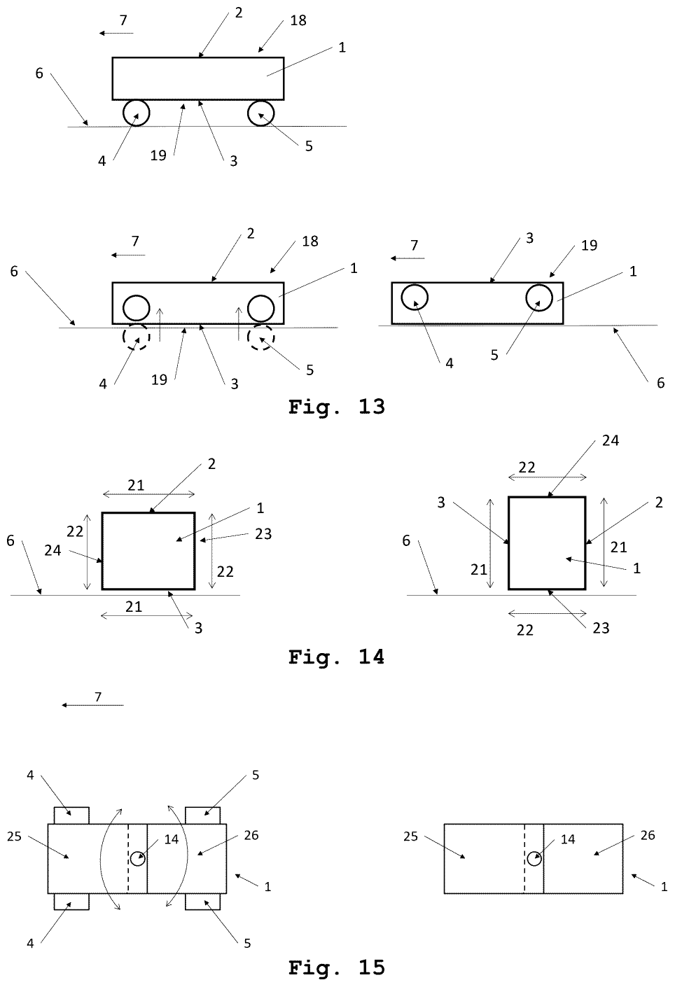

The description of FIG. 13 mentions the plate 1 being formed with a thickness required to receive the wheels 4, 5. Regardless of the feature of introducing the wheels 4, 5 into the plate 1, formation of the plate 1 with a greater thickness and thus formation of plate 1 as a cuboid may provide the advantages discussed in FIG. 14.

FIG. 14 shows an inventive embodiment according to claim 1 read together with claim 22 or an inventive embodiment according to claim 4. These inventive embodiments may have the features of other dependent claims.

The left of FIG. 14 shows the plate 1 in a front view. The plate 1 has the cross section of a rectangle having a first side length 21 and a second side length 22. Since a cuboid as plate 1 comprises, in addition to the sides 2, 3, two further sides 23, 24 included in FIG. 14 and thus the four sides 2, 3, 23, 24, the plate 1 may be arranged in four different positions by orienting either of the four sides 2, 3, 23, 24 towards the ground 6. The latter includes use of either of the sides 2, 3, 23, 24 as a sliding surface for a sliding or swinging movement or with wheels for a rolling movement on the ground 6.

When the first side length 21 and the second side length 22 are different, the top side of the plate 1 is arranged in a different respective height from the ground 6, as illustrated in FIG. 14.

In realizing claim 4, the four sides 2, 3, 23, 24 have different sliding properties regardless of the design of side lengths 22, 23.

FIG. 15 shows an inventive embodiment according to claim 1 or claim 3 or claim 4 or claim 5 read together with claim 17. This embodiment may also have the features of further dependent claims. The removable seating/holding element is not included in FIG. 15.

The plate 1 may comprise a first plate portion 25 and a second plate portion 26. The plate portions 25, 26 arranged behind one another as seen in the direction of travel 7, are connected via a hinge 14 in an exemplary manner, so that the plate portions 25, 26 can be set with respect to one another to achieve a steering effect, as illustrated in FIG. 15 by the arcuate arrows. Such a steering effect can be achieved both with a rolling movement of the vehicle, see the left of FIG. 15, and with a sliding movement of the vehicle, see the right of FIG. 15.

The hinge 14 may be executed as a ball hinge. The hinge 14 may also comprise an adjusting axis, which adjusting axis is oriented at a 90° angle to a side 2, 3 or to the ground 6.

FIG. 16 shows an inventive embodiment according to claim 1 or claim 3 or claim 4 or claim 5 read together with claim 17. This embodiment may also have the features of other dependent claims. The removable seating/holding element 8 is not included in FIG. 16.

FIG. 16 shows another way in which a hinge can be set. The plate 1 comprises a front plate subregion 12 and a rear plate subregion 13. The subregions 12, 13 are connected via a hinge 14, which hinge 14 comprises a hinge axis extending parallel to the extension direction of the plate 1.

The rear plate subregion 13 comprises on its first side 2 a wheel 5 and on its second side 3 a wheel 5′. The wheels 5, 5′ symbolize that the first side 2 and the second side 3 of the rear plate subregion 13 have generally different movement properties on the ground 6. In the case of the wheels 5, 5′, these are different rolling properties on the ground 6. Instead of a wheel or the wheels 5, 5′, the skilled person may also provide a sliding surface on the first side 2 and/or on the second side 3 and thus establish different movement properties of the sides 2, 3 on the ground 6.

The hinge 14 allows selective setting of the wheels 5, 5′ or of sliding surfaces with respect to the ground 6, so that different movement properties can be generated.

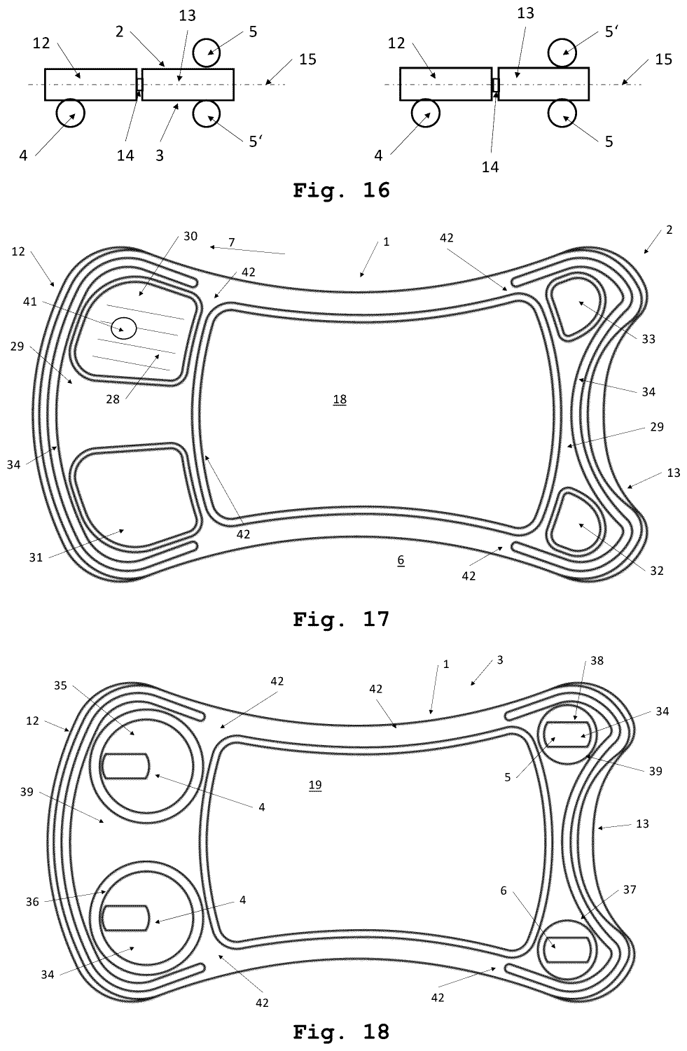

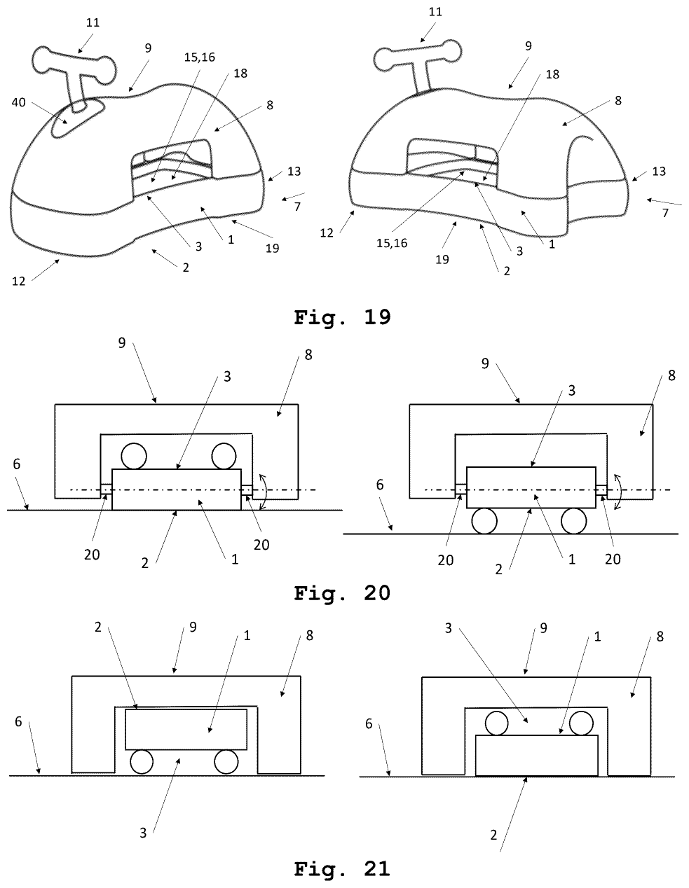

An embodiment will now be discussed based on FIGS. 17, 18 and 19, for which embodiment an unpublished prototype has been developed. FIGS. 17 and 18 show views of the sides 2, 3 of the plate 1. FIG. 19 shows perspective front and rear views of the inventive vehicle.

Provided that the seating/holding element is removable, the vehicle shown in FIGS. 17, 18 and 19 is an embodiment according to claim 1 optionally read together with at least one dependent claim.

In an imaginary integral formation of plate and seating/holding element, the vehicle shown in FIGS. 17, 18 and 19 is an embodiment according to claim 2 optionally read together with at least one dependent claim. The inventive vehicle for children comprises a plate 1 having a first side 2 (see the view in FIG. 17) and a second side 3 (see the view in FIG. 18), which sides 2, 3 are arranged opposite one another. Thus, the plate 1 has a certain thickness, which thickness is chosen by the skilled person to achieve the required stability and with regard to meeting the following structural features.

FIG. 19 shows two perspective views of the inventive vehicle.

The first side 2 comprises four first sliding surface 30, 31, 32, 33. The first sliding surfaces 30, 31, 32, 33 have first sliding properties when contacting a ground 6. The first sliding properties of the first sliding surfaces 30, 31, 32, 34 may be different among each other or among pairs thereof. In the prototype shown in FIG. 17, the first sliding surfaces 30, 31 have a first surface extension, while the first sliding surfaces 32, 33 have a smaller first surface extension. In the prototype shown, the first sliding surfaces 30, 31, 32, 33 are made out of the same surface material, which is by no means a requirement.

The sliding surfaces 30, 31, 32, 33 may also be made out of different materials.

The first sliding surfaces 30, 31, 32, 33 extend across subregions of the first side 2. The first sliding surfaces 30, 31, 32, 33 are arranged in corners of the first side 2 of the plate 1.

The first sliding surfaces 30, 31, 32, 33 are formed as planar surfaces. The first sliding surfaces 30, 31, 32, 33 comprise rills 28, only the rills in the first sliding surface 30 being designated by the reference numeral 28 for the sake of clarity. The sliding surfaces 30, 31, 32, 33 are executed to be smooth between the rills 28.

The longitudinal extension of the sliding surfaces 30, 31, 32, 33 may be oriented at an acute angle facing outwards with respect to the movement direction 7. Likewise, the rills 28 may be oriented at an acute angle facing outwards with respect to the movement direction 7.

The first sliding surfaces 30, 31, 32, 33 are formed at a height distance to a first surface 29 of the first side 2. When sliding on a planar ground (see FIG. 17), the first surface 29 does not contact the ground 6. Only the first sliding surfaces 30, 31, 32, 33 contact the ground 6, since the first sliding surfaces 30, 31, 32, 33 are executed as partial surfaces of the first side 2. Formation of the entire first surface 29 as a sliding surface would also be generally possible.

The sliding surfaces 30, 31, 32, 33 comprise a recess 41 to receive an element with special sliding properties such as, for example, a felt element. The recess 41 is only designated by a reference numeral in sliding surface 30. Two subregions in sliding surface 30 are created with different sliding properties by the introduced piece of felt.

One of the sliding surfaces 30, 31, 32, 33 may also be made completely out of felt or Teflon or another material having selected sliding properties.

The first side 2 comprises a first dwelling surface 18. Herein, the first dwelling surface 18 has the special shape of an indentation 16. The first dwelling surface 18 may also be a further unspecified subregion of the first surface 29. It is not necessarily required to indicate any delineation of the first dwelling surface 18, since the child should be able to dwell on the first side 2 in any shape or form.

The first side 2 comprises a groove 34, which groove 34 serves as a receiving device for a seating/holding element 8 to be arranged adjacent to the first side 2. The seating/holding element 8. Which seating/holding element 8 is not shown in FIG. 17, comprises a matching shape of a receiving device. Providing tongue and groove as a receiving device is a possible, advantageous form of a receiving device. Other forms of a mechanical connection are also possible.

In particular, it is possible that the tongue-and-groove connection is executed as a releasable connection of the seating/holding element 8 to the plate 1. In a preferred manner, the releasably formed tongue-and-groove connection is clamping, so that the connection is released while overcoming the clamping force.

In particular, it is possible that the tongue-and-groove connection is executed as an integral connection of plate 1 and seating/holding element 8. The plate 1 and the seating/holding element 8 may have a bonding in the area of this connection.

In the special case shown in FIGS. 17 and 18, the receiving device extends in subregions following the circumference of the plate 1. The receiving device thus follows the arcuate shape of the front plate region 12 and the rear plate region. Deflection of forces acting tangentially on the plate 1 into all directions from the seating/holding element is achieved by this special shape of the receiving device.

The plate 1 has a tapered shape. The plate 1 has a greater width in the front plate region 12 and in the rear plate region 13 as seen in the movement direction 7 than in the middle region of the plate 1. The advantage thereby achievable is discussed below based on FIG. 19.

FIG. 18 shows a top view of the second side 3 of the plate 1. While the second side 3 contacts the ground 6 in FIG. 17, it is the first side 2 that contacts the ground 6 in FIG. 18. The child may determine the travelling properties of the inventive vehicle by orienting the first side 2 and the second side 3 towards the ground 6. In the position of the plate 1 of the vehicle shown in FIG. 17, the travelling properties of the vehicle are determined by the properties of the second side 3, in particular the sliding properties of the first side 2, with the ground 6. In the position shown in FIG. 18, the travelling properties of the vehicle are determined by the properties of the first side 2, in particular the rolling properties of the wheels 4, 5 shown in FIG. 18, on a ground 6. The various designs of the sides 2, 3 to achieve certain properties of the sides 2, 3 with respect to a ground 6 have been discussed in detail above and are only mentioned by way of example in the discussion of the prototype. The prototype may also have the other designs of the sides 2, 3 discussed above instead of a planar sliding surface on the first side 2 and wheels on the second side 3.

The second side 3 comprises wheel cases 35, 36, 37, 38 to receive wheel suspensions and wheels 4, 5 not visible in FIG. 18.

The wheels space apart the second surface 39 from the ground 6 at an orientation of the second side 3 towards the ground 6.

The second side 3 comprises an indentation 16 as a second dwelling surface 19, in which context it should be noted that formation of the second dwelling surface 19 is not limited to this shape. The second dwelling surface 19 may also have a different shape, so that the child can dwell on the second side 3.

The tapered shape of the plate 1 is also clearly visible in FIG. 18. In a preferred and hence non-limiting manner, the first side 2 and the second side 3 are congruent shapes.

Like the first side 2, the second side 3 comprises a groove 34 as a receiving device, wherein the seating/holding element comprises a matching tongue as a receiving device.

The first side 2 and the second side 3 may comprise distancing elements 42, which distancing elements 42 space apart the first surface 29 and the second surface 39, respectively, from the surface of the seating/holding element 8 at least in the area of the distancing elements 42. When the distancing element 42 has a sufficiently great height extension, contact or distance between the plate 1 and the seating/holding element 8 can preferably be created by the distancing element 42. By such distancing elements 42, a noise created by a relative movement between plate 1 and seating/holding element 8 can be prevented or the height of the seat can be adjusted.

FIG. 19 shows a front and a rear perspective view of the inventive vehicle, which vehicle comprises a plate 1 and a seating/holding element 8. As described in detail above, the seating/holding element 8 may be arranged adjacent to the first side 2 or adjacent to the second side 3. Only the arrangement of the seating/holding element 8 adjacent to the second side 3 is shown in FIG. 19. An arrangement of the seating/holding element 8 adjacent to the first side 2 is also possible.

The plate 1 contacts the ground 6 with the first side 2. The plate 1, which plate 1 comprises sliding surfaces 30, 31, 32, 33 on its first side 2, may be moved sliding on the ground 6 into a movement direction 7.

The seating/holding element is arranged horizontally. The seating/holding element receives the wheels arranged on the second side 3 on its inside. The seating/holding element 8 comprises seating means 9 for the child on its top side. In an advantageous, non-limiting manner, the seating means 9 have the shape of a saddle. Accordingly, and to make it easier for the child to put their feet on the ground 6, the seating/holding element 8 has a tapered shape congruent with the shape of the plate 1 discussed above. The seating/holding element 8 and the plate 1 have a greater width in the front region of the seating/holding element 8, which front region is adjacent to the front plate region 12, and in the rear region of the seating/holding element 8, which rear region is arranged adjacent to the rear plate region 13, and a tapered shape in the middle region.

Furthermore, the seating/holding element 8 and the plate 1 have a concave shape in the rear region 12. This shape is advantageous to allow a child pushing the vehicle free movement, in particular space for their feet or knees.

The seating/holding element 8 comprises in its front region a receiving device 40 for a holding device 11 shown in FIG. 19.

The plate 1 and the seating/holding element 8 may be made out of a foam. This material is advantageous due to its low weight and elastic deformability. The receiving device 40 for the holding device comprises reinforcement to deflect forces into the seating/holding element 8.

In an advantageous manner, the plate 1 comprises an indentation 16, which indentation 16 forms a stowage space 15 to receive objects such as toys or a dwelling surface 18, 19. The indentation 16 is advantageous in that it prevents the child or objects stored in the stowage space 15 from moving or falling.

The embodiment shown in FIGS. 17, 18, 19 is also characterized by a hollow execution of the seating/holding element, so that the stowage space 15 is formed by the indentation 16 and the hollow region of the seating/holding element.

Preferably, the width of the plate (measured transversely to the movement direction 7 in the front or rear plate region 12, 13) is great or greater than the height of the seat (distance from the highest point of the seating means 9 to the ground 6). This can prevent the vehicle from tipping.

FIG. 20 shows another embodiment of the inventive vehicle according to claim 1 (releasable receiving device) or according to claim 2 (non-releasable receiving device optionally read together with at least one dependent claim). The plate 1 comprises a first side 2 with a sliding surface that is planar (in the special form shown). A bent sliding surface or any other design of the first side 2 described herein is also possible.

In the special form with wheels shown in FIG. 20, the plate 2 comprises a second side 3. Another design of the second side 3 is also possible.

The vehicle further comprises a seating element 8, which seating element 8 is coupled to the plate 1 via a receiving device. The receiving device is formed as at least one receiving hinge 20, which receiving hinge 20 is comprised by the plate 1. The hinge axis of the receiving hinge 20 extends parallel to the extension axis of the plate 1 as seen in the movement direction 7. FIG. 20 shows the special case of the plate 1 comprising a receiving hinge 20 on both ends.

By pivoting the plate 1 about the hinge axis relative to the element 8, the first side 2 or the second side 3 may selectively be oriented towards the ground. This allows setting the movement properties of the vehicle.

FIG. 20 further shows the special case of the hinge axis being arranged eccentrically with respect to the height extension of the plate 1 optionally including wheels. Thereby, height adjustment of the seating means 9 on the top side of the element 8 may also be achieved.

FIG. 21 shows another embodiment of the inventive vehicle according to claim 1 (releasable receiving device) optionally read together with at least one dependent claim. In analogy to the embodiment shown in FIG. 20, the plate 1 comprises two sides with different movement properties on a ground 6.

A seating element 8 is releasably coupled to the plate 1 via a receiving device. The seating element 8 also contacts the ground 6 and forms further sliding surfaces.

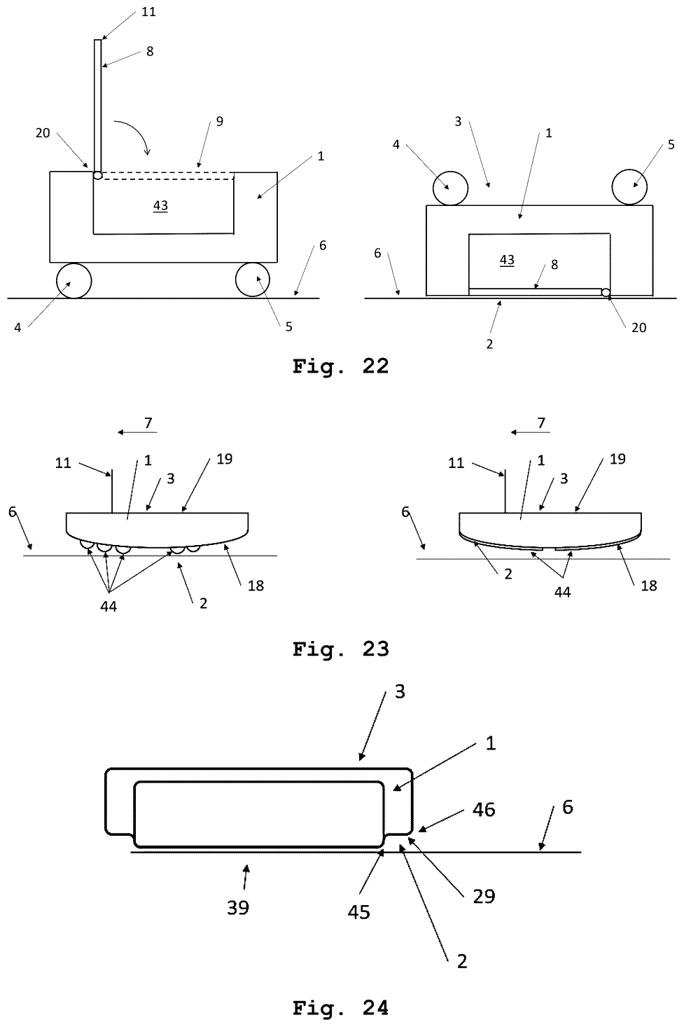

FIG. 22 shows a further embodiment of the inventive vehicle according to claim 1 (releasable receiving device) or claim 2 (non-releasable receiving device optionally read together with at least one dependent claim).

The plate 1 comprises a first side 2, which first side 2 is formed as a sliding surface. FIG. 22 shows a planar sliding surface, a bent sliding surface also being possible.

The plate 1 comprises a second side 3, wherein the second side 3 comprises wheels 4, 5 in the special case shown in FIG. 22. The second side 3 may also comprise a planar or bent sliding surface instead of the wheels 4, 5.

A seating/holding element 8 is connected to the first side 2 via a receiving device. The receiving device is formed by the receiving hinge 20, which receiving hinge 20 is comprised by the plate 1. The seating/holding element 8 hinged to the first side 2 via the receiving hinge 20 may be converted from a horizontal position as seating means 9 into a vertical position as a holding device 11 by rotating or pivoting, preferably when the second side 3 contacts the ground 6.

In an advantageous manner, the plate comprises a recess, which recess serves as a stowage space 43. This stowage space 43 can be sealed by the element 8 as seating means 9. It is also possible to provide a further element, which further element, like the element 8, is supported so as to rotate and can be used as a holding device in its folded-out position.

When the first side 2 contacts the ground 6, the seating/holding element acts as a sliding surface.

FIG. 23 shows another inventive embodiment according to claim 1 (releasable receiving device) or according to claim 2 (non-releasable receiving device optionally read together with at least one dependent claim). In particular, FIG. 23 illustrates a potential formation of sliding surfaces with reference to the embodiment shown on the top right of FIG. 9. The following is also applicable to the other potential embodiments of the sliding surfaces.

The depiction of an embodiment of the inventive vehicle on the left of FIG. 23 shows a sliding surface with protrusions 44. The protrusions 44 may be punctiform or formed extending across the width of the sliding surface (at a right angle to the image plane). As shown on the left of FIG. 34, the protrusions 44 may be executed in subregions of the sliding surface or dispersed across the entire partial surface.

The depiction of an embodiment of the inventive vehicle on the right of FIG. 23 shows a sliding surface with protrusions 44 extending in a line form or planarly.

In both embodiments, the protrusions 44 are disrupted, whereby a sound to motivate the child is created upon a swinging movement.

The formation of a sliding surface with such protrusions 44 may be regarded as formation of a multiply bent sliding surface with continuous sliding surfaces.

FIG. 24 shows a detail of an advantageous formation of a sliding surface of a first side 2 or a second side 3 in a sectional view. The sliding surface may be a sliding surface described above. This detail is applicable to the inventive embodiments.

The edge 45 of the sliding surface is arranged at a distance from the edge 46 of the side 2. In the region between the edges 45, 46, the first surface 29 of the plate 1 never contacts the ground. The skilled person may choose the distance between the edges 45, 46 to be such that a child can bring their hand into the region, but not between the sliding surface 39 and the ground 6. This prevents the child from jamming their hand or toes between the ground 6 and the sliding surface 39.

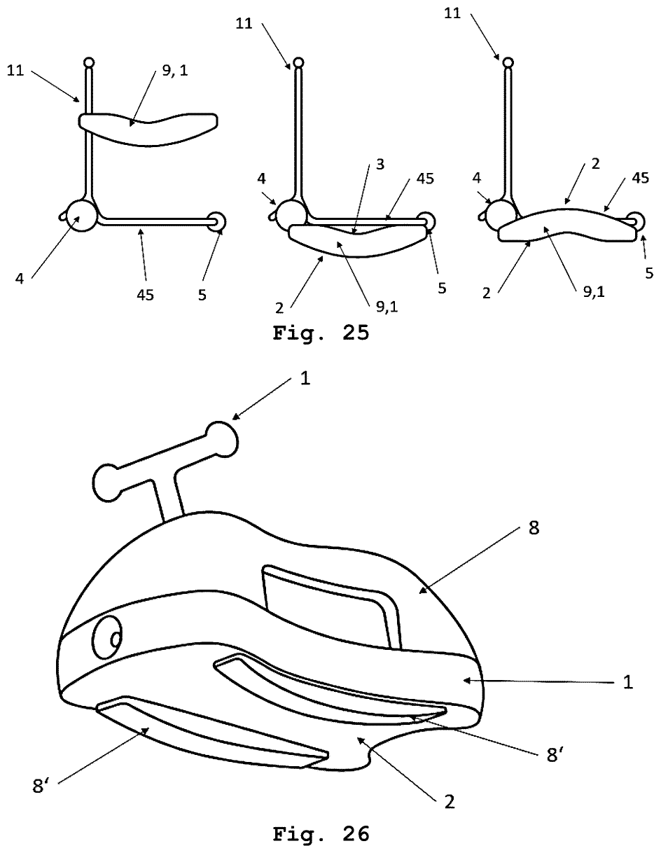

FIG. 25 shows another embodiment of the inventive vehicle according to claim 3 or claim 5 optionally read together with at least one dependent claim as well as a potential combination of the inventive vehicle with a scooter, kickboard or the like. In the following, the term ‘scooter’ is chosen, which scooter may have a weight-shift steering and/or rotary steering.

The scooter comprises a carriage 47 with at least one front wheel 4 and at least one rear wheel 5. A holding device 11 is connected to the plate 1. The carriage 47 extends essentially between the front wheel 4 and the rear wheel 5. Furthermore, seating means 9 are connected to the holding device 11 by mechanical connecting means. The seating means 9 can be released from the holding device 11.

In a potential embodiment of the invention, the inventive vehicle may form the seating means 9 in the position shown on the left of FIG. 25. The inventive vehicle may also be arranged beneath the scooter shown in the figure, so that the seating means 9 form the plate 1 with the first side 2 and the second side 3, as shown in the center on the right of FIG. 25.

In all cases shown in FIG. 25, the inventive vehicle comprises a receiving device to connect the inventive vehicle to the holding element 11 of the scooter either directly (see the left of FIG. 25) or indirectly (see the center and right of FIG. 25).

The formation of the sides 2, 3 is not limited to the sides 2, 3 shown in FIG. 25. The skilled person may apply the above description to FIG. 25.

FIG. 26 illustrates another embodiment of the inventive vehicle according to claim 1 (releasable receiving device) or claim 1 (integral formation of plate and seating/holding element). The embodiment shown in FIG. 26 may also be regarded as an embodiment according to claim 4 or claim 5 read together with claim 10 and optionally at least one independent claim.

Elements 8, 8′ are arranged on one side 2 of the plate 1, which elements 8, 8′ form another sliding surface. The elements 8, 8′ may be formed as skids. The skids may be releasably attached to the first side 2, such as by plugging, for example. The skids may be executed as a bent shape as described above.

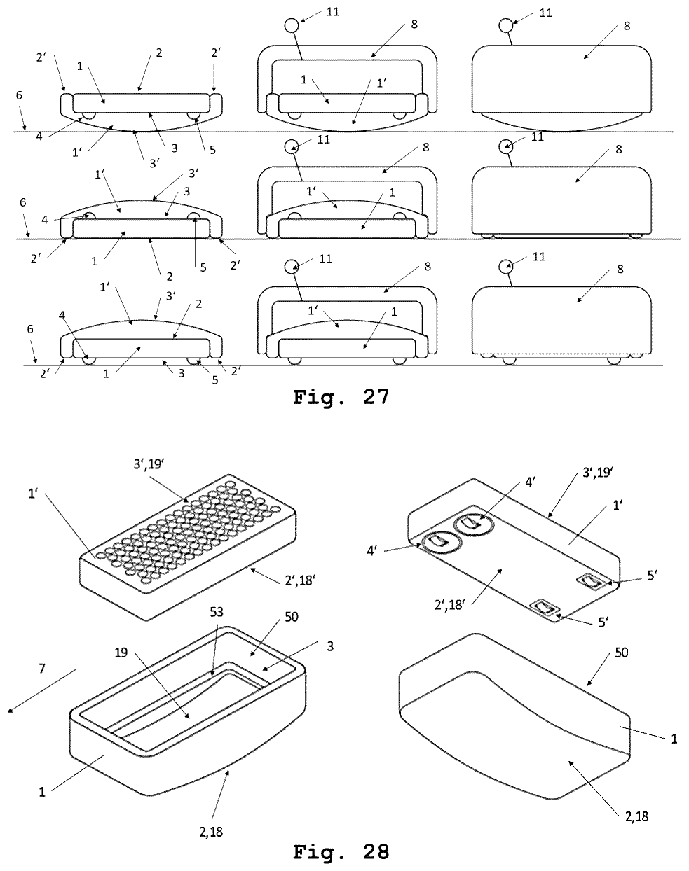

FIG. 27 shows at least one embodiment according to claim 1 (releasable receiving device) or according to claim 2 (non-releasable receiving device) optionally read together with at least one dependent claim.

FIG. 27 illustrates another embodiment of the invention. The inventive vehicle may also comprise a first plate 1 and a second plate 1′, which plates 1, 1′ can be set with respect to one another. The first plate 1 and the second plate comprise the sides 2, 3, 2′, 3′ and the sides 2′, 3′, respectively, which sides 2, 3, 2′, 3′ can be selectively contacted with the ground 6.

A seating element 8 may be added to the plate 1, 1′, wherein one plate or multiple plates among the plates 1, 1′ comprise a receiving device as the receiving device for the element 8. The element 8 may comprise a holding device 11.

The individual positions are shown in FIG. 27, the skilled person also being able to apply the above description to form the sides 2, 3 as planar or bent sliding surfaces or with wheels.

FIG. 28 illustrates the embodiment shown on the top left of FIG. 27 using exploded views. The embodiment shown in FIG. 28 is an embodiment according to claim 3 or claim 4 or claim 5 optionally read together with at least one dependent claim.

The embodiment shown in FIG. 28 comprises a plate having a first plate 1 and a second plate 1′.

The first plate 1 and the second plate 1′ are releasably connected to one another. A releasable connection may be established by a tight fit. FIG. 28 shows a potential embodiment to be described below of a releasable, tight-fit connection; further releasable, tight-fit connections are possible.

The first plate 1 comprises a first side 2, which first side 2 is formed as a bent sliding surface. FIG. 28 shows the special case of the first side 2 being bent about a single axis, which axis is oriented at a 90° angle to the movement direction 7. Bending about further axes and thus a first side 2 bent about multiple axes is also possible.

In the embodiment shown in FIG. 28, the first side 2 of the first plate 1 is contacted with a ground not included in FIG. 28.

The first side 2 of the first plate 1 forms a first dwelling surface 18. A toddler may dwell on a bent surface by sitting or standing.

The first plate 1 comprises, on its second side 3 and thus opposite the first side 2, a first opening 50, into which first opening 50 the second plate 1′ can be inserted up to a stop 53 and thus partially. The stop 53 limits the insertion depth of the first plate 1′ into the second plate 1″. The second plate 1′ can be partly releasably inserted into the first opening 50 in that a second side 3′ of the second plate 1′ can be contacted with a ground.

A toddler may sit down in the first opening. A closure of the opening may serve as a second dwelling surface 19 of the first plate 1.

The second plate 1′ comprises the second side 3′. The second side 3′ is formed to be planar with knobs. Formation of the knobs on the planar sliding surface constitutes a special case; it is also possible to form the second side 3 without knobs. The knobs may be in the shape of hemispheres or the like.

A toddler may dwell on the second side 3′ of the second plate 1′. The second side 3′ of the second plate 1′ is a second dwelling surface 19 of the second plate 1′.

The second plate 1′ comprises a first side 2′, on which first side 2′ wheels 4′, 5′ are arranged. The front wheels 4′ are executed to be settable via a steering mechanism. The rear wheels 5′ are not executed to be settable. A toddler may dwell on a first dwelling surface 18′ of the second plate 1′ between the wheels 4′, 5′. The first side 2′ of the second plate 1′ thus represents the first dwelling surface 18′ of the second plate 1′.

The first plate 1 encloses the peripheral region of the second plate 1′ when the second plate 1′ is inserted into the first opening 50.

The releasable connection of the plate 1, 1′ is achieved via the first opening 50 on the second side 3 of the first plate 1, into which opening 50 the second plate 1′ can be inserted. The second plate 1′ can be inserted into the first plate 1 with its first side 2′ or its second side 2′ facing outward.

The first side 2 of the first plate 1 or the first side 2′ of the second plate 1′ or the second side 3′ of the second plate 1′ can thereby be contacted with the ground. Preferably, the first plate 1 comprises a stop 53 to limit the insertion depth of the second plate 1′ into the first opening. The second plate 1′ inserted into the first opening 50 contacts the stop 53 with its first side 2′ or its second side 3′.

The formation of the plates 1, 1′ is applicable to FIGS. 28 to 32.

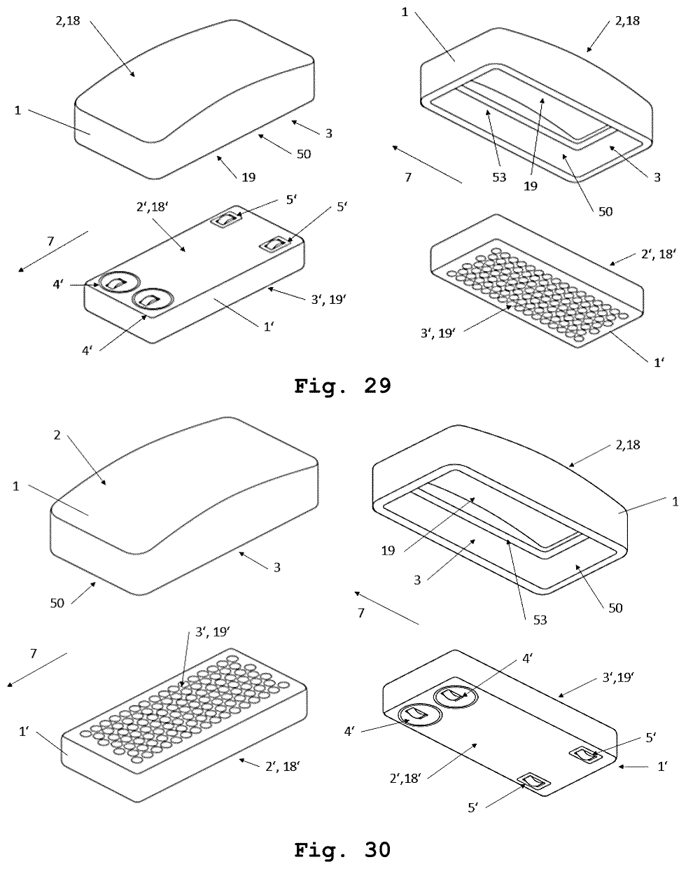

FIG. 29 illustrates the embodiment shown on the left in the middle row of FIG. 27 using exploded views. The plates 1, 1′ of the embodiment shown in FIG. 29 correspond to the embodiment shown in FIG. 28. However, the plates 1, 1′ are arranged in a different constellation.

The embodiment shown in FIG. 29 is an embodiment according to claim 3 or claim 4 or claim 5 optionally read together with at least one dependent claim.

While the first side 2 of the first plate 1 in FIG. 28 does not contact the ground not included in FIG. 28, the second side 3′ of the second plate 1′ in FIG. 29 faces the ground not included in FIG. 29. In FIG. 28, the second side 3′ of the second plate 1′ can serve as a dwelling surface. In FIG. 29, the first side 2 of the first plate 1 serves as a dwelling surface.

FIG. 30 illustrates another form of arrangement for the plates 1, 1′, as shown on the left in the middle row in FIG. 27. The embodiment shown in FIG. 30 is an embodiment according to claim 3 or claim 4 or claim 5 optionally read together with at least one independent claim.

The plates 1, 1′ are formed like the plates in FIG. 28 or FIG. 29. In FIG. 30, the plates 1, 1′ are arranged with respect to one another in a different constellation than FIG. 28 or FIG. 29.

In FIG. 30, the first side 2′ of the second plate 1′ faces the ground. The first side 2 of the first plate 1 serves as the dwelling surface 18.

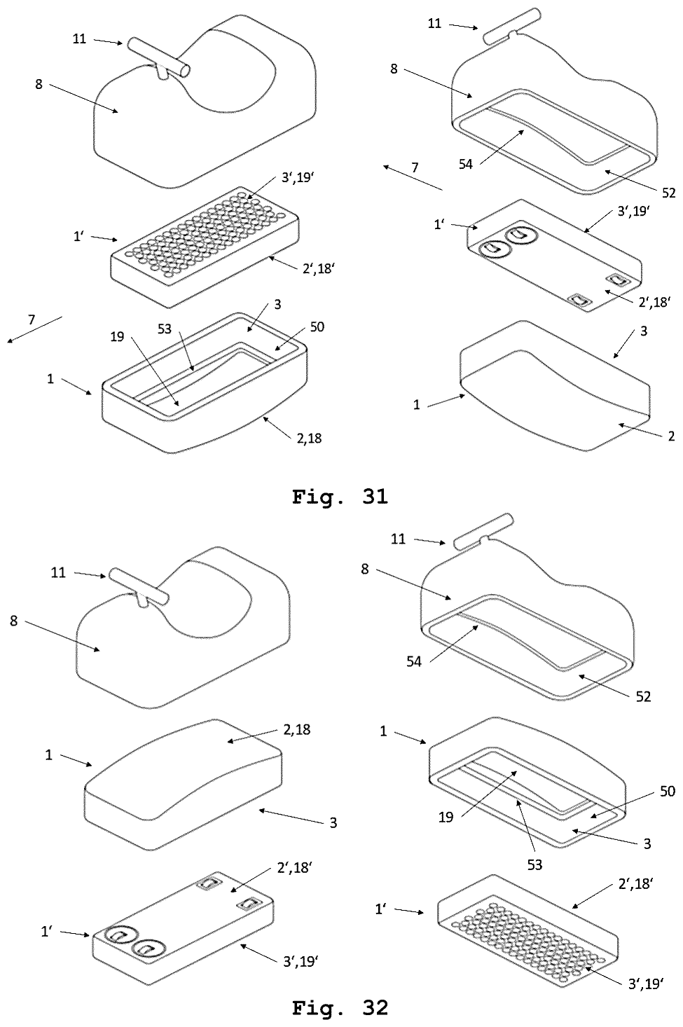

A seating/holding element may be releasably arranged on the embodiment shown in FIG. 28 or in FIG. 29 or in FIG. 30, whereby the embodiments shown in FIGS. 31, 32, 33 are achieved. For this reason, the description of FIGS. 28, 29 and 30 is applicable to the design of plates 1, 1′ in the figure.

FIG. 31 illustrates the embodiment shown in the top center and on the top right of FIG. 27 using an exploded three-dimensional view, a sectional view and a top view.

FIG. 31 or FIG. 32 or FIG. 33 shows an embodiment according to claim 3 or claim 4 or claim 5 optionally read together with at least one independent claim.

The embodiment shown in FIG. 31 comprises a removable seating/holding element 8 with a holding device 11 in addition to the plates 1, 1′. The seating/holding element 8 has an opening 52 on its side facing the first plate 1 and/or the second plate, into which opening 52 the first plate 1 and/or the second plate 1′ can be partially inserted. The seating/holding element 8 and the opening 52 in particular are formed such that the first plate 1 or second plate 1′ facing a ground contacts said ground. Preferably, the seating/holding element 8 comprises a stop 54 within the opening 52, which stop 54 limits the insertion depth of the plates 1, 1′ into the opening.

The seating/holding element 8 comprises a dwelling surface with the holding device 11 on its side opposite to the opening 52. The dwelling surface and the holding device 11 are formed such that a toddler may grab the holding device 11 while, for example, sitting on the dwelling surface as seating means 9.

The embodiment shown in FIG. 31 can be converted into various other constellations, which is why the connections between the plates 1, 1′ and one of the plates 1, 1′ with the seating/holding element 8 are executed to be releasable.

The constellation shown in FIG. 31 allows swinging or sliding on a ground.

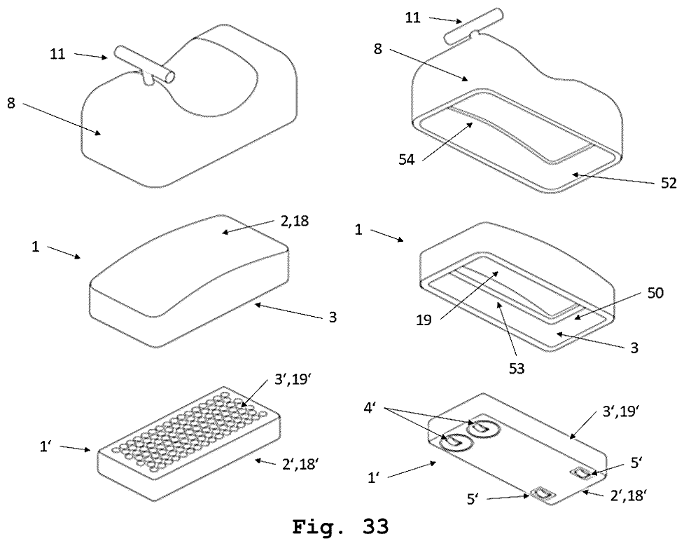

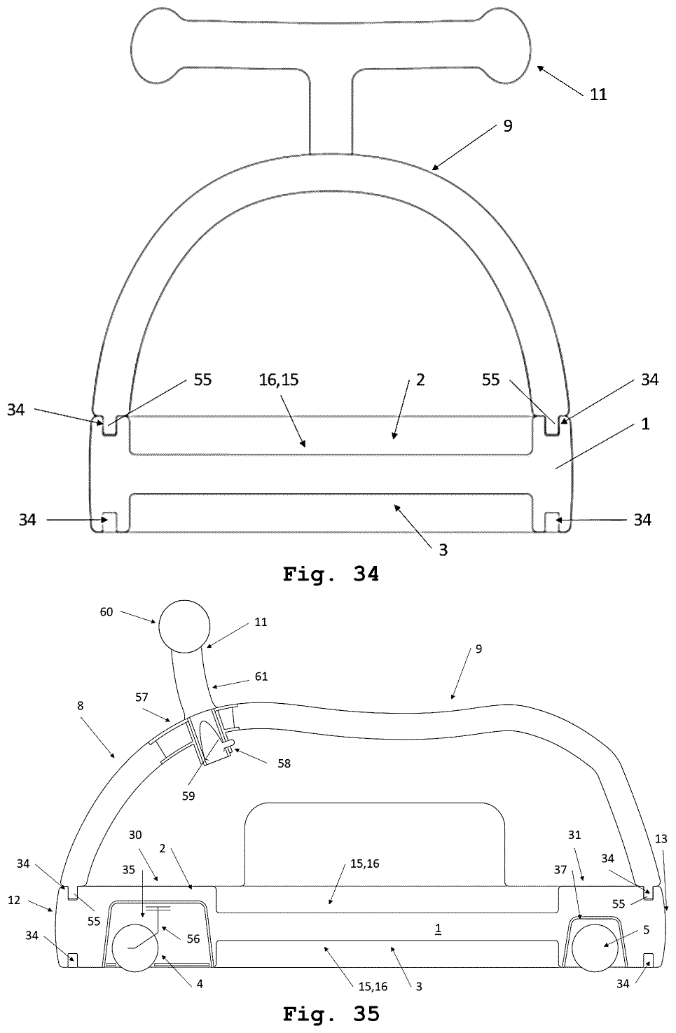

The constellation shown in FIG. 31 may be redesigned to that shown in FIG. 32. The embodiment shown in FIG. 32 allows sliding on a ground, wherein the knobs on the second side 3′ of the second plate 1′ are contacted with the ground.

The constellation shown in FIG. 31 may be redesigned to that shown in FIG. 33. The embodiment shown in FIG. 33 allows rolling on a ground, wherein the wheels 4′, 5′ are contacted with the ground on the first side 2′ of the second plate 1′.

FIGS. 34 and 35 show sectional views of the embodiment shown in FIGS. 17, 18 and 19. FIG. 34 shows a cross-sectional view with a sectional plane at a right angle to the longitudinal axis of plate 1 and at a right angle to the movement direction 7 when travelling straight ahead. FIG. 35 shows a longitudinal sectional view with a sectional plane parallel to the longitudinal axis of the plate 1 or parallel to the movement direction 7 when travelling straight ahead.

The plate 1 comprises a first side 2 and a second side 3. Wheels 4, 5 are arranged on the second side 3, as can be seen in particular from FIG. 35. The plate 1 comprises a groove 34 that faces upward and downward on each of its first side 2 and its second side 3, wherein the groove 34 that faces upward can be engaged by a tongue 55 of a seating/holding element 8 that faces downward. The seating/holding element 8 is to the plate 1 by the releasable tongue-and-groove connection. Preferably, the tongue-and-groove connection undergoes bias by inserting the tongue 55 into the groove 34. This bias counteracts release of the tongue-and-groove connection; for release, the existing tongue-and-groove connection must be overcome.

The bias may be caused by the tongue 55 having a greater width (as can be seen from FIGS. 34 and 35 in the image plane) than the groove 34, so that the tongue 55 is inserted into the groove 34 while deforming the tongue 55 and/or the groove. Preferably, the tongue 55 and/or the groove 34 are made out of a deformable material. Deformation of the tongue 55 and/or the groove 34 when inserting the tongue 55 into the groove 34 creates frictional forces in the contact surfaces between tongue 55 and groove 34, which frictional forces counteract release of the connection.

The seating/holding element 8 comprises a holding device 11 and seating means 9 (covered by the holding device in FIG. 34) on its side that faces upward. The holding device 11 comprises a transverse rod 60 and a rod 61 that is vertical in at least one view. The transverse rod 60 is arranged centered on the top end of the vertical rod 61, so that the transverse rod 60 and the vertical rod 61 form a T-shape.

Further advantageous details of this inventive embodiment can be seen in FIG. 35, which details are described below.

The front wheel 4 is executed as a settable wheel. The wheel can be set about a steering axis 56 that extends vertically by way of example in FIG. 35. The toddler dwelling on the inventive vehicle may set the front wheel 4 by pushing the plate 1 into a certain direction. The rear wheel 5 is not executed to be steerable/settable. The front wheel 4 and the rear wheel 5 are each arranged in a wheel case 35, 37. Each wheel case 35, 37 is inserted into the second side 3 of the plate 1 via a recess, in the case of a wheel case with a round cross section preferably via a bore. The execution shown in FIG. 35 has the wheel cases 35, 37 executed conically in their vertical extension. The wheel cases 35, 37 are preferably pressed into the correspondingly executed bores in the plate 1.

The first side 2 comprises the sliding surfaces 30, 31.

The plate 1 comprises an indentation 16 on the first side 2 and on the second side 3, which indentation 16 defines a stowage space 15.

The holding device 11 is connected to the seating/holding element 8 via a latch connection. The holding device 11 comprises a bore extending in a radial direction in the region of the bottom end of the vertical rod 61. A pin-shaped element of a spring element 59 is inserted through the bore of the vertical 61 and through the bore of the pipe piece 58. In the embodiment shown in FIG. 35, the spring element 59 is executed as a leaf spring, which leaf spring is supported on the side inner surface of the vertical rod 61 opposite the bore. In the inserted position of the holding element 11, the axes of the bores of the pipe piece 58 and the vertical rod 61 are oriented coextensively.

For this purpose, a receiving plate 57 is inserted into a recess of the seating/holding element 8. The receiving plate 57 comprises the pipe piece 58, into which pipe piece 58 the vertical rod 61 of the holding device 11 is inserted.

The receiving plate 57 causes dispersion of the forces acting between the holding device 11 and the seating/holding element 8. This is advantageous in particular when the seating/holding element 8 is made out of a foamed material.

1-25. (canceled)

26. A vehicle for children, comprising:
a plate having a first side and a second side, the first and second sides being arranged one of opposite to one another and at an arrangement angle to one another, the first side forming a top side of the plate and the second side forming a bottom side of the plate when the vehicle is used;
wherein the first side comprises at least one first sliding surface having first sliding properties for the at least one first sliding surface to slide on the ground;
wherein one of:
the at least one first sliding sliding surface is formed as a planar sliding surface extending across one of a subregion of the first side and an entirety of the first side, and
the at least one first sliding surface is formed as a single surface extending across the first side and bent about a first axis, the first axis extending at a 90° angle to a movement direction and in a first plane spaced apart from a ground; and
wherein the second side comprises at least a single wheel to displace the vehicle into the movement direction on the ground;
wherein at least one of the first side comprises a first dwelling surface and the second side comprises a second dwelling surface;
wherein at least one of the first side comprises a first receiving device and the second side comprises a second receiving device, the first receiving device and the second receiving device being configured to releasably receive a seating-holding element, the seating-holding element configured to be one of:
converted from a first position for use as a seating element into a second position for use as a holding element,
exclusively a seating element, and
exclusively a holding element;
wherein the seating-holding element is formed from one of a solid material, a bloatable element, and an inflatable element; and
wherein one of the first receiving device and the second receiving device is formed to arrange the seating-holding element with respect to the plate in one of a horizontal position and a vertical position.

27. The vehicle of claim 26, wherein:
the one of the first receiving device and the second receiving device device for releasably receiving the seating-holding element is formed assuming the vertical position; and
the seating-holding element arranged in the vertical position comprises a holding device on a free end.

28. The vehicle of claim 26, wherein the seating-holding element comprises at least one of a planar sliding surface and a bent sliding surface on a seating-holding element surface that is configured to be able to face the ground.

29. The vehicle of claim 26, wherein:
the vehicle comprises at least one of a front wheel and a rear wheel; and
at least one of the front wheel, the rear wheel, and the sliding surface is configured to be set to change the movement direction.

30. The vehicle of claim 26, wherein:
the plate comprises a front plate region and a rear plate region; and
the front plate region and the rear plate regions are connected by a hinge.

31. The vehicle of claim 26, wherein:
one of:
the one of the first receiving device and the second receiving device is formed in a shape of tongue and groove, the tongue being introduced into the groove, and
the one of the first receiving device and the second receiving device is formed as a covering connection; and
the seating-holding element is placed covering the plate or the plate is placed covering the seating-holding element.

32. The vehicle of claim 26, wherein the one of the first receiving device and the second receiving device extends along an edge or a subregion of the plate.

33. The vehicle of claim 26, wherein the one of the first receiving device and the second receiving device is formed as a receiving hinge or as a connector in at least one subregion.

34. The vehicle of claim 26, wherein the one of the first receiving device and the second receiving device comprises a distancing element.

35. The vehicle of claim 26, wherein:
the seating-holding element is formed as a hollow body; and
the seating-holding element is arranged on the plate and the plate forms a stowage space.

36. The vehicle of claim 26, wherein:
the plate is formed as a prism having four sides; and
one side of the prism is formed as a planar or bent sliding surface or comprises wheels.

37. The vehicle of claim 26, wherein:
the plate comprises a sliding surface that can be set towards one side of the plate; and
the sliding surface can be set in height or inclination towards the plate.

38. The vehicle of claim 26, wherein the plate has a greater width on an end than in a middle region.

39. The vehicle of claim 38, wherein the seating-holding element has a greater width on a seating-holding element end than in a seating-holding element middle region.

40. The vehicle of claim 26, wherein:
the plate comprises a first plate and a second plate; and
the first plate and the second plate are configured to be set towards one another.

41. A vehicle for children, comprising:
a plate having a first side and a second side, the first side and the second side being arranged one of opposite to one another and at an arrangement angle to one another, the first side configured to form a top side of the plate and the second side configured to form a bottom side of the plate when the vehicle is used;
wherein the first side comprises at least one first sliding surface having first sliding properties for the surface to slide on the ground;
wherein one of:
the at least one first sliding surface is formed as a planar sliding surface extending across one of a subregion of the first side and across an entirety of the first side; and
the at least one first sliding surface is formed as a single surface extending across the first side and bent about a first axis, the first axis extending at a 90° angle to a movement direction and in a first plane spaced apart from a ground; and
wherein the second side comprises at least a single wheel to displace the vehicle into the movement direction on the ground;
wherein at least one of the first side comprises a first dwelling surface and the second side comprises a second dwelling surface;
wherein a seating-holding element formed integrally with the plate is arranged on at least one of the first side and on the second side, the seating-holding element configured to be one of:
converted from a first position for use as a seating element into a second position for use as a holding element,
formed exclusively as a seating element; and
formed exclusively as a holding element;
wherein the seating-holding element is formed from one of a solid material, a bloatable element, and an inflatable element; and
wherein a receiving device is formed to arrange the seating-holding element with respect to the plate in one of a horizontal position and a vertical position.

42. The vehicle of claim 41, wherein:
the vehicle comprises at least one of a front wheel and a rear wheel; and
at least one of the front wheel, the rear wheel, and the sliding surface is configured to change the movement direction.

43. The vehicle of claim 41, wherein the plate has a greater width on an end than in a middle region.

44. The vehicle of claim 43, wherein the seating-holding element has a greater width on a seating-holding element end than in a seating-holding element middle region.
